(19) United States
(12) Patent Application Publication
(10) Pub. No.: US 2002/0049288 A1
(43) Pub. Date: Apr. 25, 2002

(54) Ether-amine based polymerization catalysts, compositions and processes using same

(76) Inventors: Christopher Goh, San Francisco, CA (US); Gary M. Diamond, San Jose, CA (US); Vince Murphy, Campbell, CA (US); Margarete K. Leclerc, Mountain View, CA (US); Keith Hall, San Jose, CA (US); Anne M. LaPointe, Sunnyvale, CA (US); Thomas R. Boussie, Menlo Park, CA (US); Cheryl Lund, Milpitas, CA (US); Tetsuo Uno, Santa Clara, CA (US)

Correspondence Address: PENNIE AND EDMONDS, 1155 AVENUE OF THE AMERICAS, NEW YORK, NY, 100362711

(21) Appl. No.: 09/825,746

(22) Filed: Apr. 3, 2001

Related U.S. Application Data
(60) Provisional application No. 60/194,650, filed on Apr. 4, 2000.

(51) Int. Cl. C08F 4/06

(52) U.S. Cl. 526/172; 502/150; 502/152; 502/155; 502/162

(57) ABSTRACT

The inventions disclosed herein are new complexes and catalysts comprising metal-ligand complexes or compositions of metal precursors and ligands (and optionally activators) that catalyze polymerization and copolymerization reactions, particularly with monomers that are olefins, diolefins or acetylenically unsaturated. These compositions can also polymerize monomers that have polar functionalities in homopolymerizations or copolymerizations. Also, diolefins in combination with ethylene or α-olefins or 1,1-disubstituted olefins may be co-polymerized. The new catalyst compositions can be prepared by combining a metal precursor with a suitable ligand and, optionally, an activator or combination of activators. The main feature of this invention is the use of new metal ligand complexes to provide the active polymerization catalysts.

### CROSS REFERENCE TO RELATED APPLICATIONS

This application claims priority under 35 U.S.C. § 119(e) to Provisional Application Ser. No. 60/194,650, filed Apr. 4, 2000, the contents of which are incorporated herein by reference.

### FIELD OF THE INVENTION

The present invention relates to new complexes and compositions that provide useful catalysts for polymerizations.

### BACKGROUND OF THE INVENTION

Ancillary (or spectator) ligand-metal coordination complexes (e.g., organometallic complexes) and compositions are useful as catalysts, additives, stoichiometric reagents, monomers, solid state precursors, therapeutic reagents and drugs. Ancillary ligand-metal coordination complexes of this type can be prepared by combining an ancillary ligand with a suitable metal compound or metal precursor in a suitable solvent at a suitable temperature. The ancillary ligand contains functional groups that bind to the metal center(s), remain associated with the metal center(s), and therefore provide an opportunity to modify the steric, electronic and chemical properties of the active metal center(s) of the complex.

Certain known ancillary ligand-metal complexes and compositions are catalysts for reactions such as oxidation, reduction, hydrogenation, hydrosilylation, hydrocyanation, hydroformylation, polymerization, carbonylation, isomerization, metathesis, carbon-hydrogen activation, carbon-halogen activation, cross-coupling, Friedel-Crafts acylation and alkylation, hydration, dimerization, trimerization, oligomerization, Diels-Alder reactions and other transformations.

One example of the use of these types of ancillary ligand-metal complexes and compositions is in the field of polymerization catalysis. In connection with single site catalysis, the ancillary ligand offers opportunities to modify the electronic and/or steric environment surrounding an active metal center. This allows the ancillary ligand to assist in the creation of possibly different polymers.

Group IV metallocene based catalysts are generally known for polymerization reactions. See, generally, “Chemistry of Cationic Dicyclopentadienyl Group 4 Metal-Alkyl Complexes”, Jordan, Adv. Organometallic Chem., 1991, Vol. 32, pp. 325-153 and “Stereospecific Olefin Polymerization with Chiral Metallocene Catalysts”, Brintzinger, et al., Angew. Chem. Int. Ed. Engl., 1995, Vol. 34, pp. 1143-1170, and the references therein, all of which is incorporated herein by reference. There is continued interested in the next generation of non-metallocene based catalysts that can provide attractive alternatives to metallocene catalysts. See, e.g., “The Search for New-Generation Olefin Polymerization Catalysts: Life beyond Metallocenes”, Gibson, et al., Angew. Chem. Int. Ed., 1999, vol. 38, pp. 428-447; WO 96/33202; and Organometallics 1999, 18, pp. 3649-3670; each of which is incorporated herein by reference. In addition, it is always a desire to discover new catalysts that will catalyze or assist in catalysis of reactions differently from known systems. This invention describes new complexes, catalysts and processes for the polymerization of olefins, diolefins, or acetylenically unsaturated monomers.

### SUMMARY OF THE INVENTION

The inventions disclosed herein are new complexes and catalysts comprising metal-ligand complexes or compositions of metal precursors and ligands (and optionally activators) that catalyze polymerization and copolymerization reactions, particularly with monomers that are olefins, diolefins or acetylenically unsaturated. These compositions can also polymerize monomers that have polar functionalities in homopolymerizations or copolymerizations. Also, diolefins in combination with ethylene or α-olefins or 1,1-disubstituted olefins may be co-polymerized. The new catalyst compositions can be prepared by combining a metal precursor with a suitable ligand and, optionally, an activator or combination of activators. The main feature of this invention is the use of new metal ligand complexes to provide the active polymerization catalysts.

It is an object of this invention to provide metal ligand complexes that can act as polymerization catalysts, and in some embodiments hafnium metal ligand complexes.

It is a further object of this invention to polymerize olefins and acetylenically unsaturated monomers with metal ligand complexes.

It is still a further object of this invention to polymerize olefins and acetylenically unsaturated monomers with the metal ligand complexes that additionally comprise an activator or combination of activators.

Metal complexes, compositions or compounds using the disclosed ligands are within the scope of this invention. The metal ligand complexes may be in a neutral or charged state. The ligand to metal ratio may also vary, the exact ratio being dependent on the identity of the metal and ligand of the metal ligand complex. The metal ligand complex or complexes may take may different forms, for example they may be monomeric, dimeric or higher orders thereof.

In another aspect of the invention, a polymerization process is disclosed for monomers. The polymerization process involves subjecting one or more monomers to the catalyst compositions or complexes of this invention under polymerization conditions. The polymerization process can be continuous, batch or semi-batch and can be homogeneous, supported homogeneous or heterogeneous. Another aspect of this invention relates to arrays of ligands, metal precursors and/or metal ligand complexes. These arrays are useful for the high speed or combinatorial materials science discovery or optimization of the catalyst compositions or complexes disclosed herein.

Further aspects of this invention will be evident to those of skill in the art upon review of this specification.

### BRIEF DESCRIPTION OF THE DRAWING

FIGS. 1A-1E depict ligands that are useful with this invention.

### DETAILED DESCRIPTION OF THE INVENTION

The inventions disclosed herein include metal complexes and compositions, which are useful as catalysts for polymerization reactions.

As used herein, the phrase “characterized by the formula” is not intended to be limiting and is used in the same way that “comprising” is commonly used. The term “independently selected” is used herein to indicate that the R groups, e.g., R¹, R², R³, R⁴, and R⁵ can be identical or different (e.g. R¹, R², R³, R⁴, and R⁵ may all be substituted alkyls or R¹ and R² may be a substituted alkyl and R³ may be an aryl, etc.). Use of the singular includes use of the plural and vice versa (e.g., a hexane solvent, includes hexanes). A named R group will generally have the structure that is recognized in the art as corresponding to R groups having that name. The terms “compound” and “complex” are generally used interchangeably in this specification, but those of skill in the art may recognize certain compounds as complexes and vice versa. For the purposes of illustration, representative certain groups are defined herein. These definitions are intended to supplement and illustrate, not preclude, the definitions known to those of skill in the art.

The term “alkyl” is used herein to refer to a branched or unbranched, saturated or unsaturated acyclic hydrocarbon radical. Suitable alkyl radicals include, for example, methyl, ethyl, n-propyl, 1-propyl, 2-propenyl (or allyl), vinyl, n-butyl, t-butyl, 1-butyl (or 2-methylpropyl), etc. In particular embodiments, alkyls have between 1 and 200 carbon atoms, between 1 and 50 carbon atoms or between 1 and 20 carbon atoms.

“Substituted alkyl” refers to an alkyl as just described in which one or more hydrogen atom attached to any carbon of the alkyl is replaced by another group such as a halogen, aryl, substituted aryl, cycloalkyl, substituted cycloalkyl, and combinations thereof. Suitable substituted alkyls include, for example, benzyl, trifluoromethyl and the like.

The term “heteroalkyl” refers to an alkyl as described above in which one or more hydrogen atoms attached to any carbon of the alkyl is replaced by a heteroatom selected from the group consisting of N, O, P, B, S, Si, Sb, Al, Sn, As, Se and Ge. This same list of heteroatoms is useful throughout this specification. The bond between the carbon atom and the heteroatom may be saturated or unsaturated. Thus, an alkyl substituted with a heterocycloalkyl, substituted heterocycloalkyl, heteroaryl, substituted heteroaryl, alkoxy, aryloxy, boryl, phosphino, amino, silyl, thio, or seleno is within the scope of the term heteroalkyl. Suitable heteroalkyls include cyano, benzoyl, 2-pyridyl, 2-furyl and the like.

The term “cycloalkyl” is used herein to refer to a saturated or unsaturated cyclic non-aromatic hydrocarbon radical having a single ring or multiple condensed rings. Suitable cycloalkyl radicals include, for example, cyclopentyl, cyclohexyl, cyclooctenyl, bicyclooctyl, etc. In particular embodiments, cycloalkyls have between 3 and 200 carbon atoms, between 3 and 50 carbon atoms or between 3 and 20 carbon atoms.

“Substituted cycloalkyl” refers to cycloalkyl as just described including in which one or more hydrogen atom attached to any carbon of the cycloalkyl is replaced by another group such as a halogen, alkyl, substituted alkyl, aryl, substituted aryl, cycloalkyl, substituted cycloalkyl, heterocycloalkyl, substituted heterocycloalkyl, heteroaryl, substituted heteroaryl, alkoxy, aryloxy, boryl, phosphino, amino, silyl, thio, seleno and combinations thereof. Suitable substituted cycloalkyl radicals include, for example, 4-dimethylaminocyclohexyl, 4,5-dibromocyclohept-4-enyl, and the like.

The term “heterocycloalkyl” is used herein to refer to a cycloalkyl radical as described, but in which one or more or all carbon atoms of the saturated or unsaturated cyclic radical are replaced by a heteroatom such as nitrogen, phosphorous, oxygen, sulfur, silicon, germanium, selenium, or boron. Suitable heterocycloalkyls include, for example, piperazinyl, morpholinyl, tetrahydropyranyl, tetrahydrofuranyl, piperidinyl, pyrrolidinyl, oxazolinyl and the like.

“Substituted heterocycloalkyl” refers to heterocycloalkyl as just described including in which one or more hydrogen atom attached to any atom of the heterocycloalkyl is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heterocycloalkyl radicals include, for example, N-methylpiperazinyl, 3-dimethylaminomorpholinyl and the like.

The term “aryl” is used herein to refer to an aromatic substituent which may be a single aromatic ring or multiple aromatic rings which are fused together, linked covalently, or linked to a common group such as a methylene or ethylene moiety. The aromatic ring(s) may include phenyl, naphthyl and biphenyl, among others. In particular embodiments, aryls have between 1 and 200 carbon atoms, between 1 and 50 carbon atoms or between 1 and 20 carbon atoms.

“Substituted aryl” refers to aryl as just described in which one or more hydrogen atom attached to any carbon is replaced by one or more functional groups such as alkyl, substituted alkyl, cycloalkyl, substituted cycloalkyl, heterocycloalkyl, substituted heterocycloalkyl, halogen, alkylhalos (e.g., CF₃), hydroxy, amino, phosphido, alkoxy, amino, thio, nitro, and both saturated and unsaturated cyclic hydrocarbons which are fused to the aromatic ring(s), linked covalently or linked to a common group such as a methylene or ethylene moiety. The common linking group may also be a carbonyl as in benzophenone or oxygen as in diphenylether or nitrogen in diphenylamine.

The term “heteroaryl” as used herein refers to aromatic rings in which one or more carbon atoms of the aromatic ring(s) are replaced by a heteroatom(s) such as nitrogen, oxygen, boron, selenium, phosphorus, silicon or sulfur. Heteroaryl refers to structures that may be a single aromatic ring, multiple aromatic ring(s), or one or more aromatic rings coupled to one or more non-aromatic ring(s). In structures having multiple rings, the rings can be fused together, linked covalently, or linked to a common group such as a methylene or ethylene moiety. The common linking group may also be a carbonyl as in phenyl pyridyl ketone. As used herein, rings such as thiophene, pyridine, isoxazole, phthalimide, pyrazole, indole, furan, etc. or benzo-fused analogues of these rings are defined by the term “heteroaryl.”

“Substituted heteroaryl” refers to heteroaryl as just described including in which one or more hydrogen atoms attached to any atom of the heteroaryl moiety is replaced by another group such as a halogen, alkyl, substituted alkyl, aryl, substituted aryl, heteroaryl, substituted heteroaryl, alkoxy, aryloxy, boryl, phosphino, amino, silyl, thio, seleno and combinations thereof. Suitable substituted heteroaryl radicals include, for example, 4-N,N-dimethylaminopyridine.

The term “alkoxy” is used herein to refer to the —OZ¹ radical, where Z¹ is selected from the group consisting of alkyl, substituted alkyl, cycloalkyl, substituted cycloalkyl, heterocylcoalkyl, substituted heterocycloalkyl, silyl groups and combinations thereof as described herein. Suitable alkoxy radicals include, for example, methoxy, ethoxy, benzyloxy, t-butoxy, etc. A related term is “aryloxy” where Z¹ is selected from the group consisting of aryl, substituted aryl, heteroaryl, substituted heteroaryl, and combinations thereof. Examples of suitable aryloxy radicals include phenoxy, substituted phenoxy, 2-pyridinoxy, 8-quinalinoxy and the like.

As used herein the term “silyl” refers to the —SiZ¹Z²Z³ radical, where each of Z¹, Z², and Z³ is independently selected from the group consisting of hydrogen, alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein the term “boryl” refers to the —BZ¹Z² group, where each of Z¹ and Z² is independently selected from the group consisting of hydrogen, alkyl, substituted alkyl, cycloalkyl, heterocycloalkyl, heterocyclic, aryl, substituted aryl, heteroaryl, substituted heteroaryl, alkoxy, aryloxy, amino, silyl and combinations thereof.

As used herein, the term “phosphino” refers to the group —PZ¹Z², where each of Z¹ and Z² is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof.

As used herein, the term “phosphine” refers to the group: PZ¹Z²Z³, where each of Z¹, Z³ and Z² is independently selected from the group consisting of hydrogen, substituted or unsubstituted alkyl, cycloalkyl, heterocycloalkyl, heterocyclic, aryl, substituted aryl, heteroaryl, silyl, alkoxy, aryloxy, amino and combinations thereof.

The term “amino” is used herein to refer to the group —NZ¹Z², where each of Z¹ and Z² is independently selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “amine” is used herein to refer to the group: NZ¹Z²Z³, where each of Z¹, Z² and Z² is independently selected from the group consisting of hydrogen, alkyl, substituted alkyl, cycloalkyl, substituted cycloalkyl, heterocycloalkyl, substituted heterocycloalkyl, aryl (including pyridines), substituted aryl, heteroaryl, substituted heteroaryl, alkoxy, aryloxy, silyl and combinations thereof.

The term “thio” is used herein to refer to the group —SZ¹, where Z¹ is selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “seleno” is used herein to refer to the group —SeZ¹, where Z¹ is selected from the group consisting of hydrogen, alkyl, substituted alkyl, cycloalkyl, substituted cycloalkyl, heterocycloalkyl, substituted heterocycloalkyl, aryl, substituted aryl, heteroaryl, substituted heteroaryl, alkoxy, aryloxy, silyl and combinations thereof.

The term “saturated” refers to lack of double and triple bonds between atoms of a radical group such as ethyl, cyclohexyl, pyrrolidinyl, and the like.

The term “unsaturated” refers to the presence one or more double and triple bonds between atoms of a radical group such as vinyl, acetylide, oxazolinyl, cyclohexenyl, acetyl and the like.

The term “benzylic” refers to sp³ carbon atoms that are α to an aryl, substituted aryl, heteroaryl or substituted heteroaryl group.

Suitable ligands useful in this invention can be characterized by the following general formula:

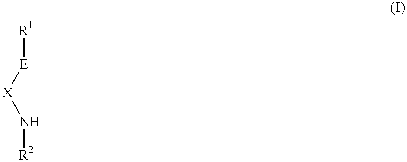

wherein E is selected from the group consisting of O, S, Se, and Te, and each R¹ and R² is independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof; X is any covalent bridging moiety, provided that X is not a benzylic carbon where the benzylic carbon atom is bound to the NHR² fragment. “Covalent bridging moiety” generally refers to a moiety that will bond with E and N, and in some contexts may simply be referred to as a bridge. Optionally, R¹ and/or R² may joined together with X in a ring structure. More specific groups for R¹ and R² can be found in the definitions, above.

In one embodiment, the ligands of formula (I) do not include any ligands described in EP 095 0667 A2, which is incorporated herein by reference.

In another embodiment, the ligands of formula (I) do not include any ligands described in Murray, U.S. Pat. No. 6,103,657, which is incorporated herein by reference.

In yet another embodiment, the ligands of the invention do not include any compound represented by formulae (IIa) and (IIb) shown below:

[chemical structure]

wherein X′ and Y′ are each heteroatoms; Cyclo is a cyclic moiety; each R^{1′} is independently a group containing 1 to 50 atoms selected from the group consisting of hydrogen and Group 13 to 17 elements, and two or more adjacent R^{1′} groups may be joined to form a cyclic moiety; each R^{2′} is independently a group containing 1 to 50 atoms selected from the group consisting of hydrogen and Group 13 to 17 elements, and two or more adjacent R^{2′} groups may be joined to form a cyclic moiety; Q′ is a bridging moiety; and m is an integer from 0 to 5.

In another embodiment, the ligands of the invention do not include any compound represented by formulae (IIa) and (IIb) shown above where X′ is N and Q′ is CR^{3′} R^{4′} where R^{3′} and R^{4′} are independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof.

In another embodiment, the ligands of the current invention do not include any compound represented by formula (XVI):

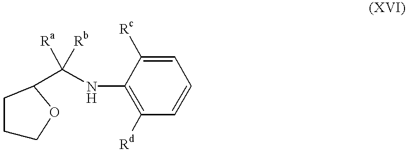

wherein each R^{a} and R^{b} are each independently selected from the group consisting of alkyl, aryl, substituted aryl, heteroaryl, substituted heteroaryl and hydrogen; and R^{c} and R^{d} are each independently selected from the group consisting of alkyl, aryl and hydrogen.

In more specific embodiments of the ligands of formula (I), E is selected from O and S, and R¹ and R² are independently selected from alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, and silyl. In a more specific embodiment X is a bridging group comprising an alkyl, substituted alkyl, heteroalkyl, substituted heteroalkyl, aryl, substituted aryl, heteroaryl, or substituted heteroaryl, with the same proviso detailed above.

In those embodiments where R¹ is joined together with X in a ring structure, the ring (including R¹ and E) has from 3-30 non-hydrogen atoms as part of the backbone of the ring. Specific examples of R¹ and X together are dimethylene (giving a three membered ring), trimethylene (giving a four membered ring), tetramethylene (giving a five membered ring, such as a tetrahydrofuran where E═O, or a tetrahydrothiophen where E═S), 3-oxopentylene (giving a six membered ring) and the like. The ring may also be unsaturated such as in the case where E═O and the ring generates a furan ring.

In those embodiments where R is joined together with X in a ring structure, the ring (including R and E) has from 3-30 non-hydrogen atoms as part of the backbone of the ring. Specific examples of R² and X together are dimethylene (giving a three membered ring, trimethylene (giving a four membered ring), tetramethylene (giving a five membered ring), 3-oxopentylene (giving a six membered ring) and the like. The ring may also be unsaturated such as in the case where the ring generates a pyrrole.

In more specific embodiments the ligands useful in this invention may be characterized by the formula:

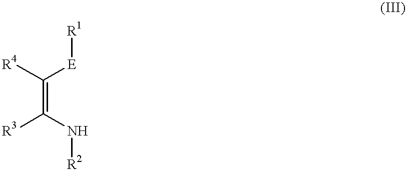

where E, R¹, R² are as defined previously for formula (I) and R³ and R⁴ are independently selected from the group hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof. Optionally, R³ and R⁴ may be joined together in a ring or multi-ring structure, with the ring(s) having from 3-30 non-hydrogen atoms. More specific groups for R³ and R⁴ can be found in the definitions, above.

The joining of R³ and R⁴ in a ring structure is one preferred embodiment of this invention and an even more specifically preferred embodiment is where the ligands useful in this invention may be characterized by the general formula:

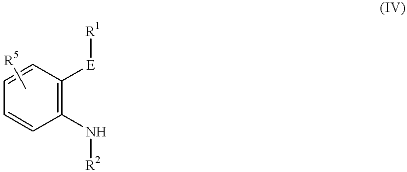

where E, R¹, R² are as defined previously for formula (I) and each R⁵ is independently selected from the group alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof. The substitution depicted for R⁵

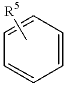

represents the situation where one or more of the hydrogen atoms on the benzene ring can be substituted by R⁵. Thus, there may be up to four R⁵ groups. Two or more R⁵ groups may be joined to form a ring fused system having from 3-30 non-hydrogen atoms in addition to the benzene ring, e.g. generating a napthyl or anthracenyl group. More specific groups for R⁵ can be found in the definitions, above.

In other embodiments of this invention, the useful ligands may be characterized by the formula:

[chemical structure]

(V)

where E and R² are as defined previously; R⁶ and R are independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof; and each R⁸ is independently selected from the group alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof. The ring structure

[chemical structure]

(referred to as formula V, herein) represents a ring structure made up from between 3-30 non-hydrogen atoms as part of the backbone of the ring. In the context of formula I, above, the ring structure of formula V represents the optional combination of R¹ and X together in a ring structure. Formula V comprises a single ring, bicyclic ring or higher number of fused rings. The substitution for the ring structure

[chemical structure]

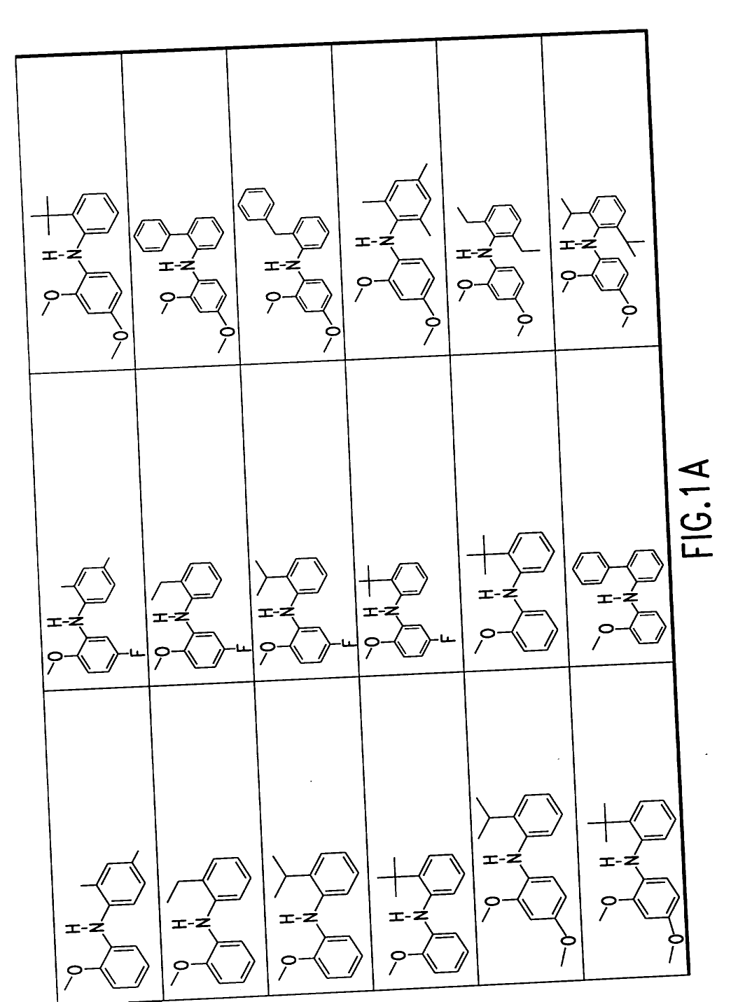

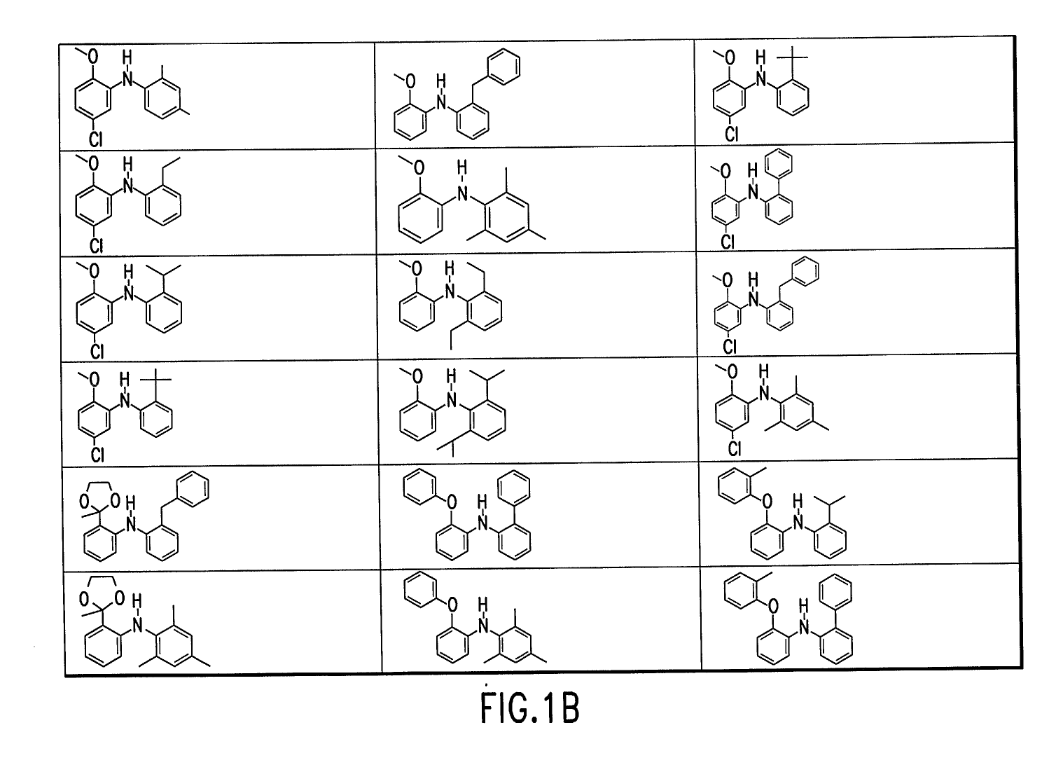

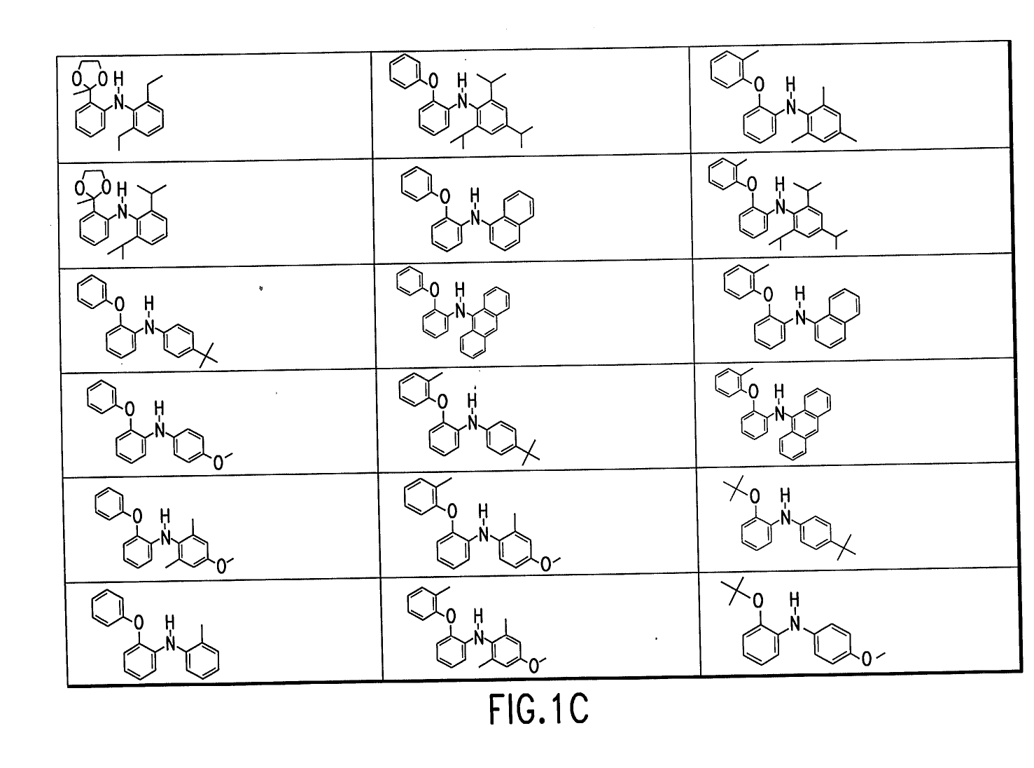

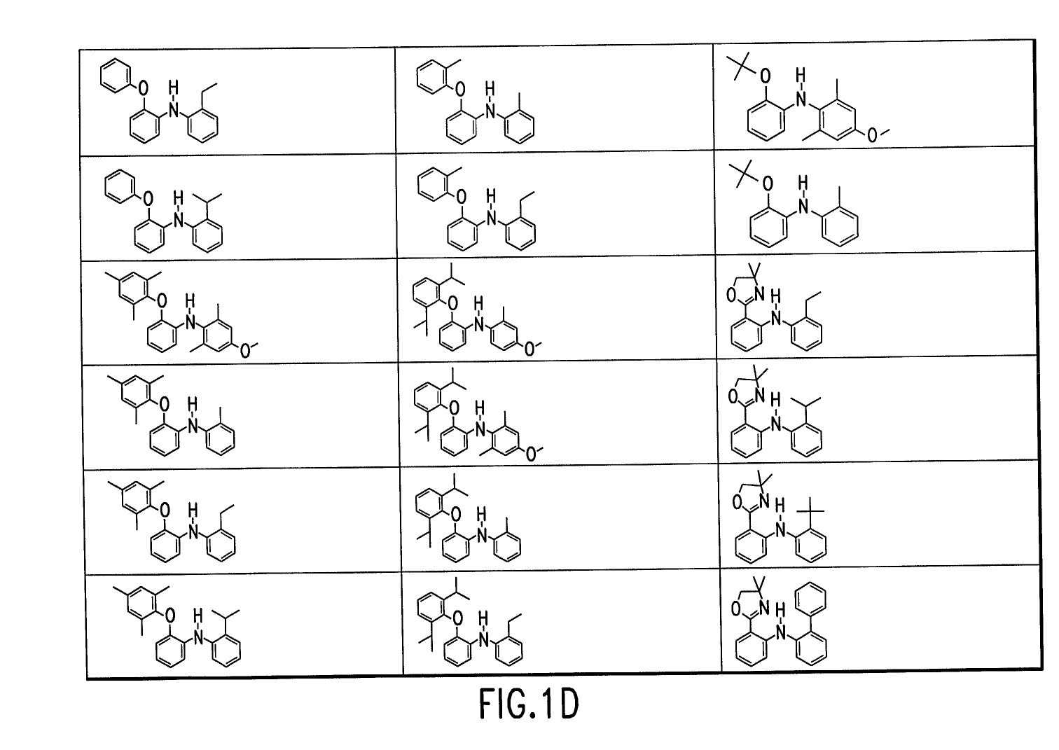

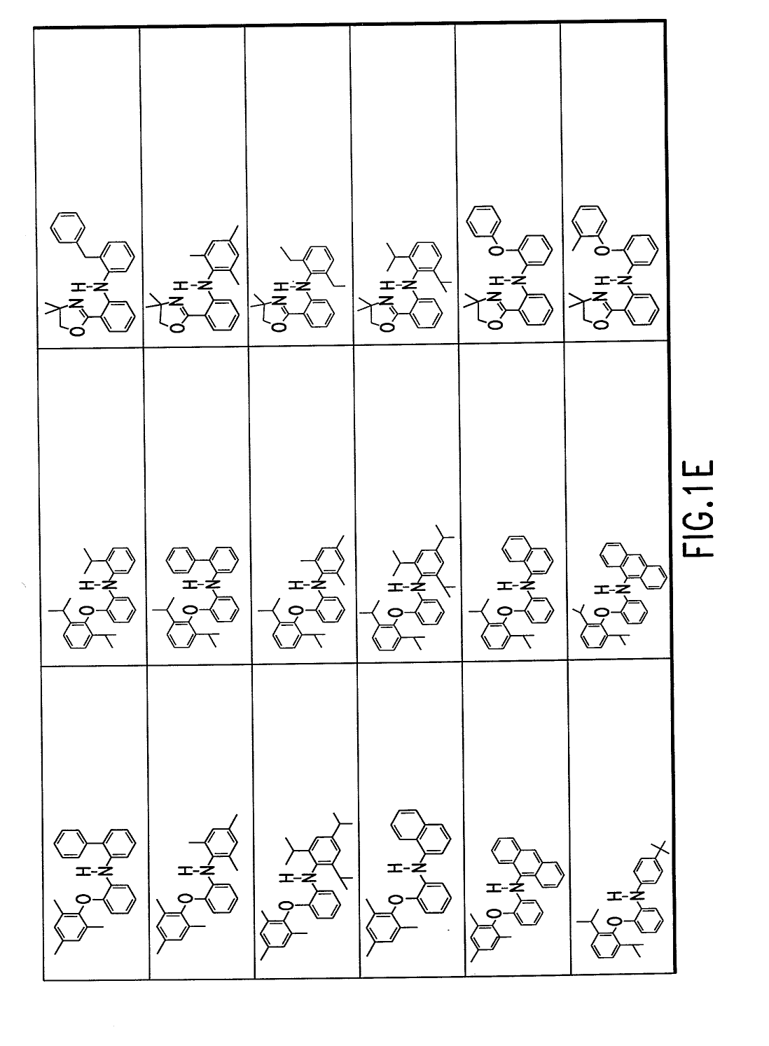

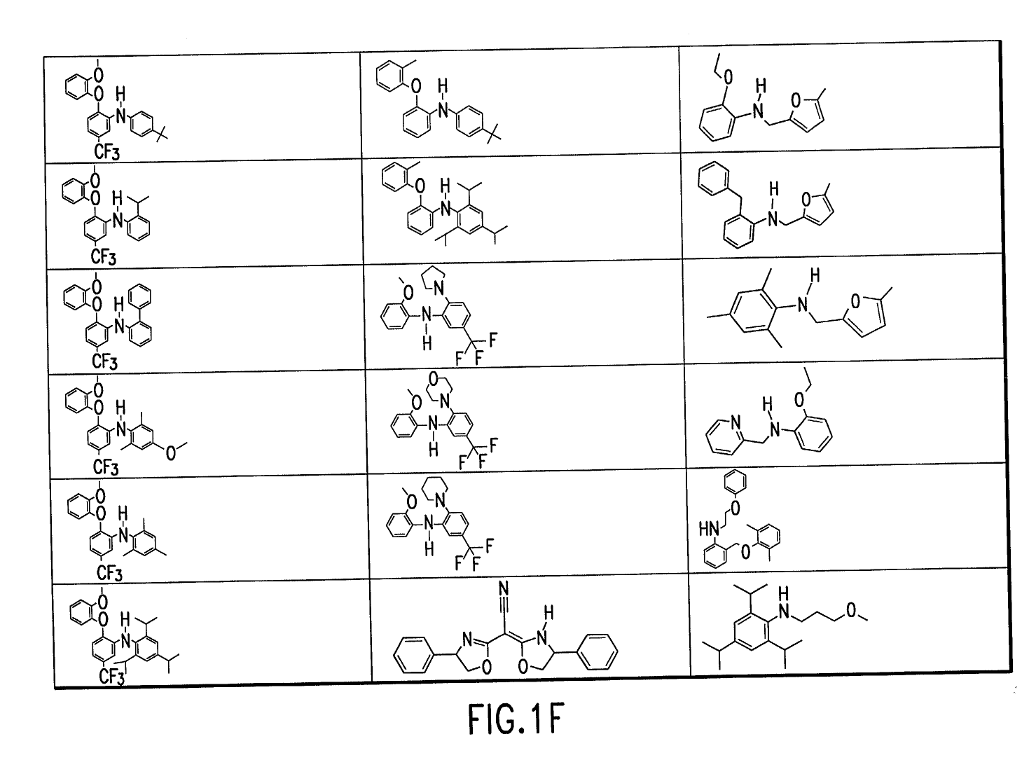

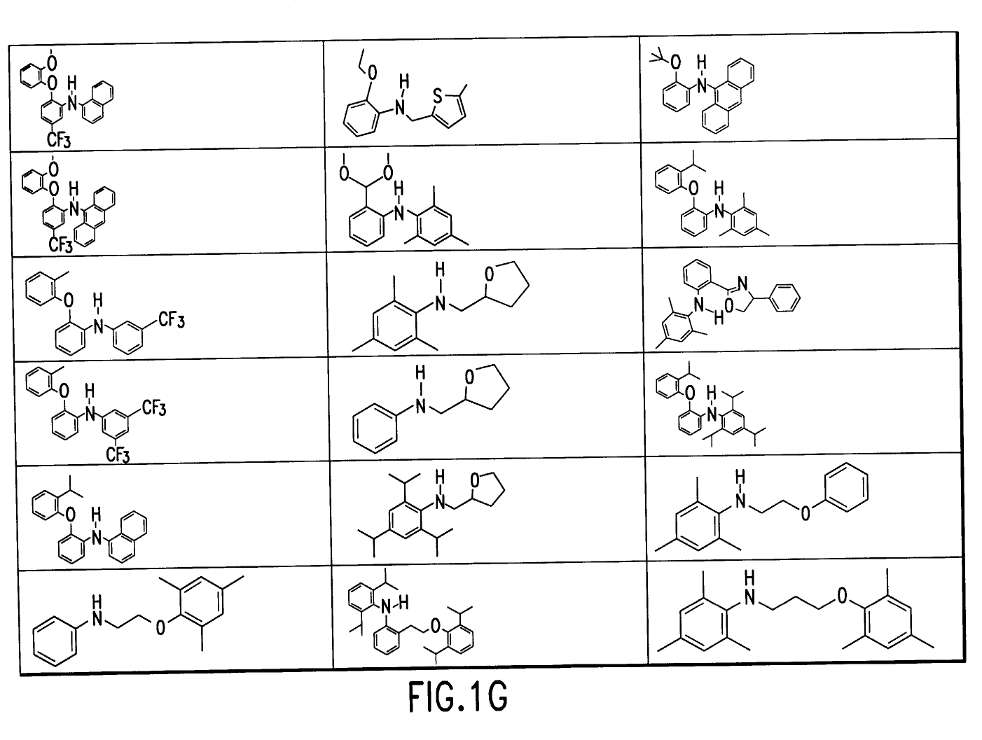

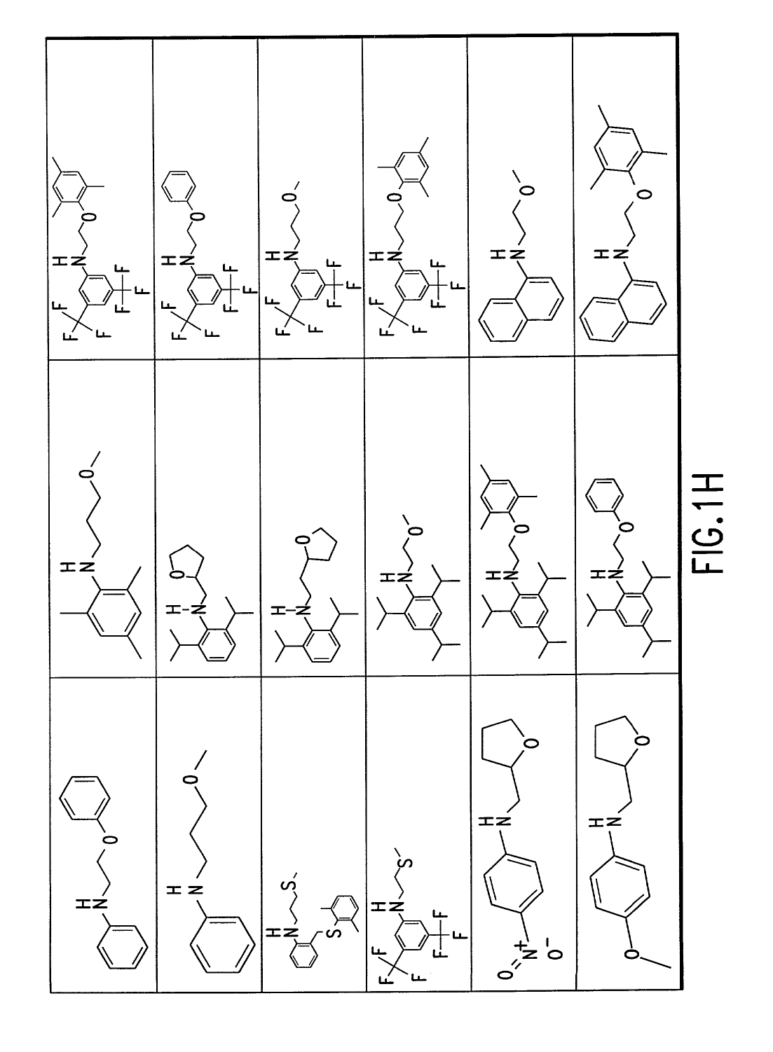

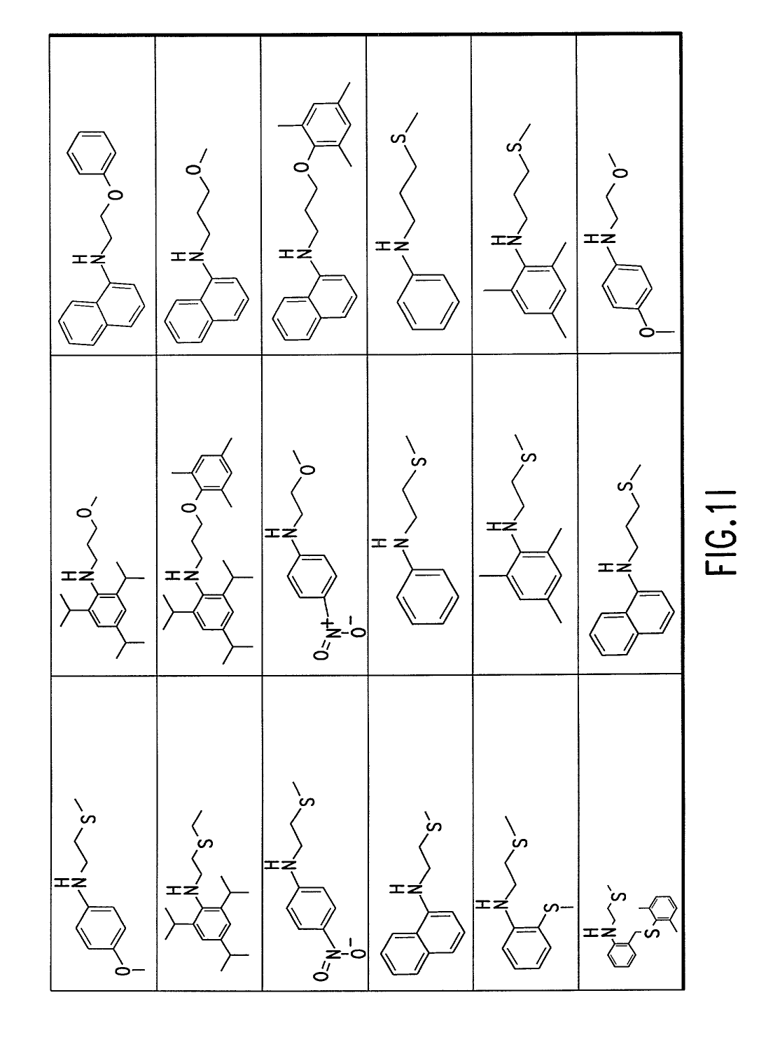

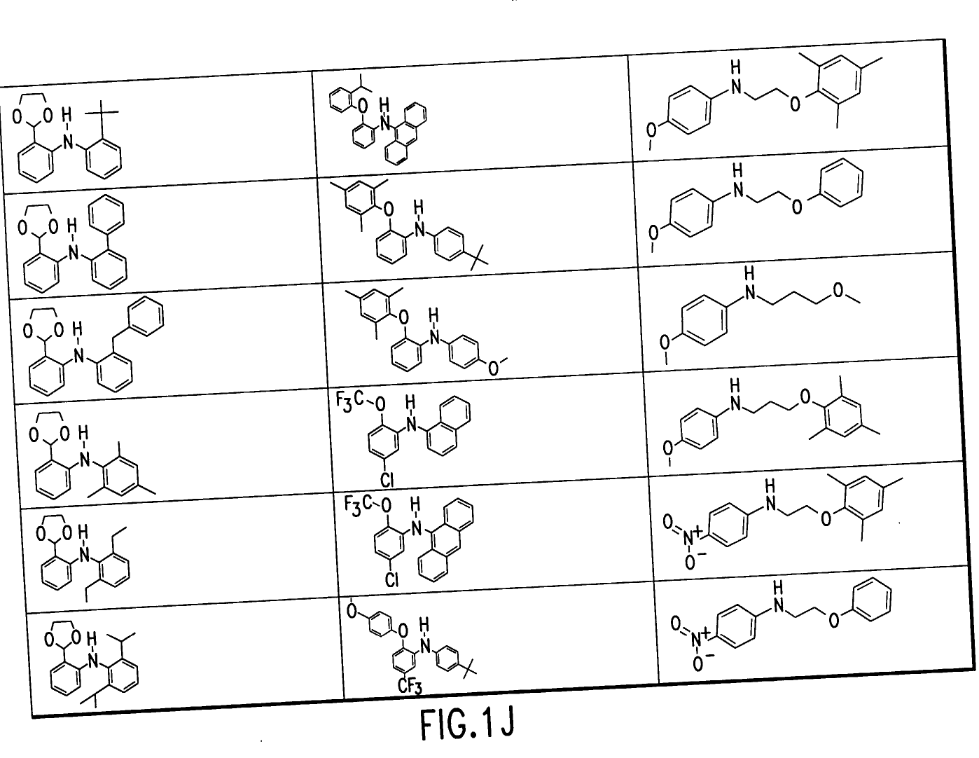

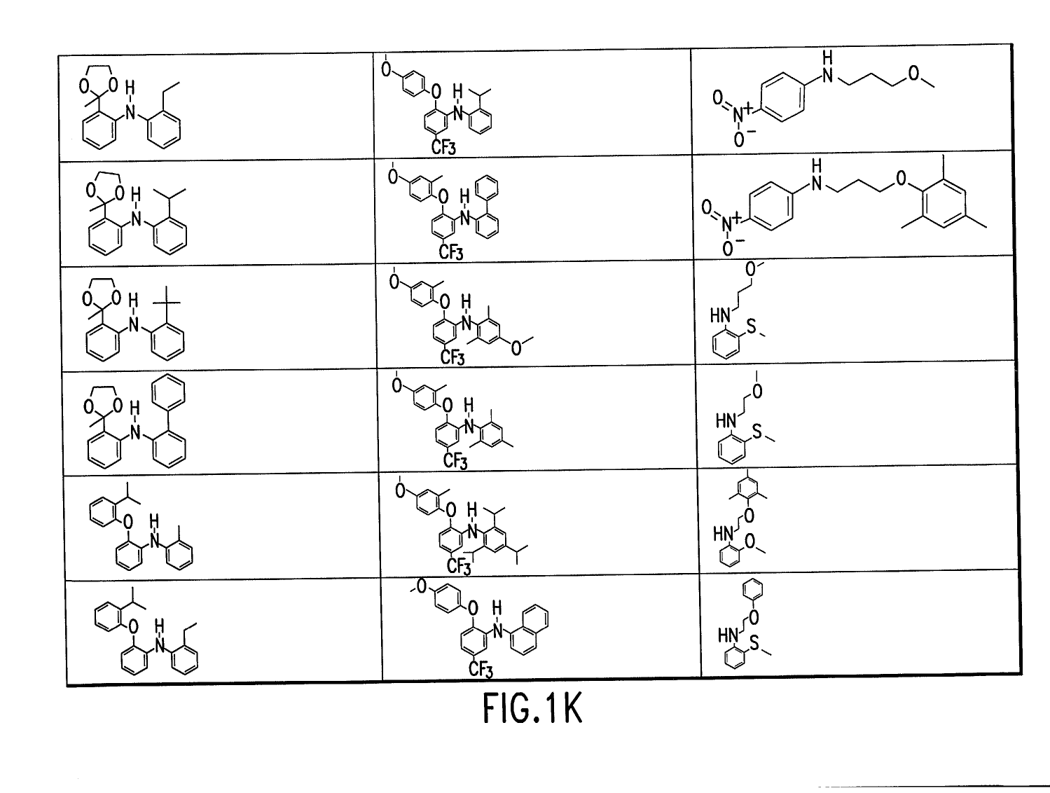

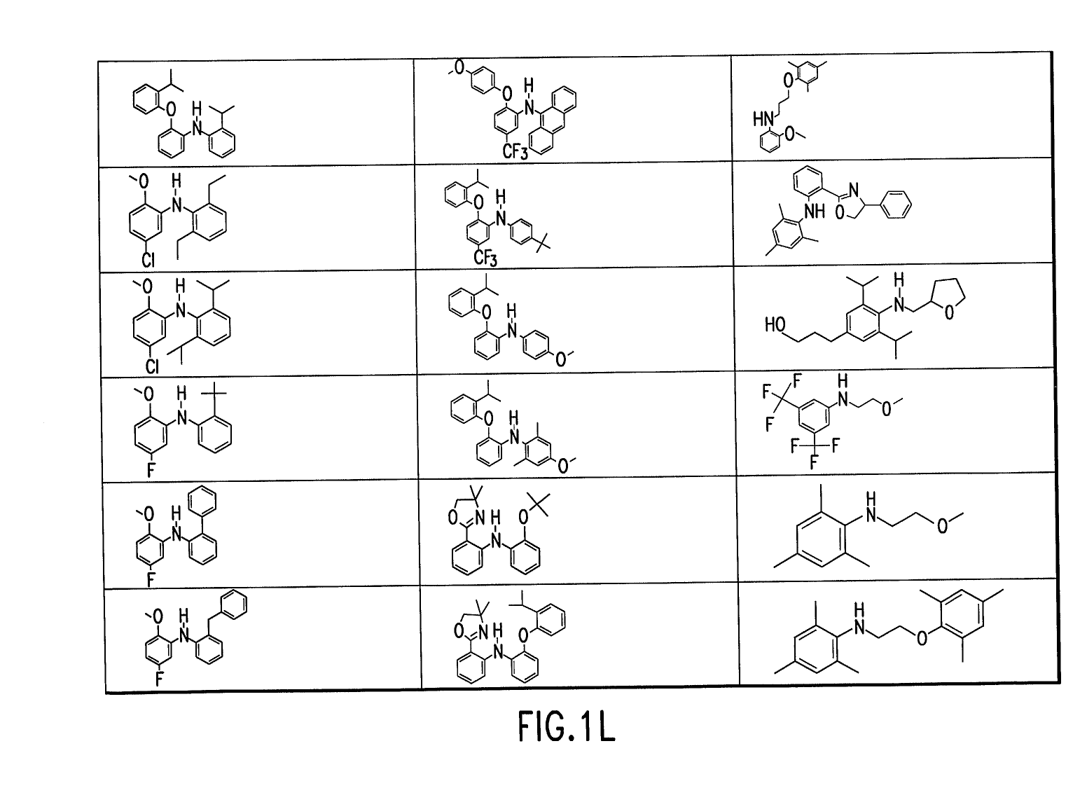

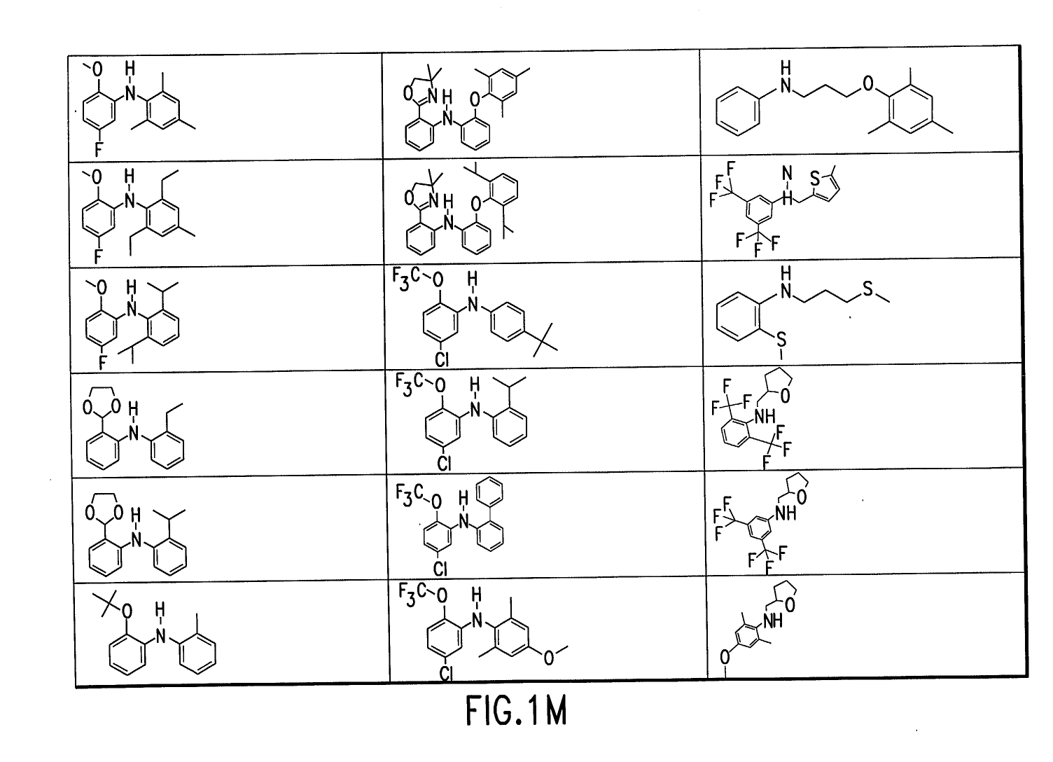

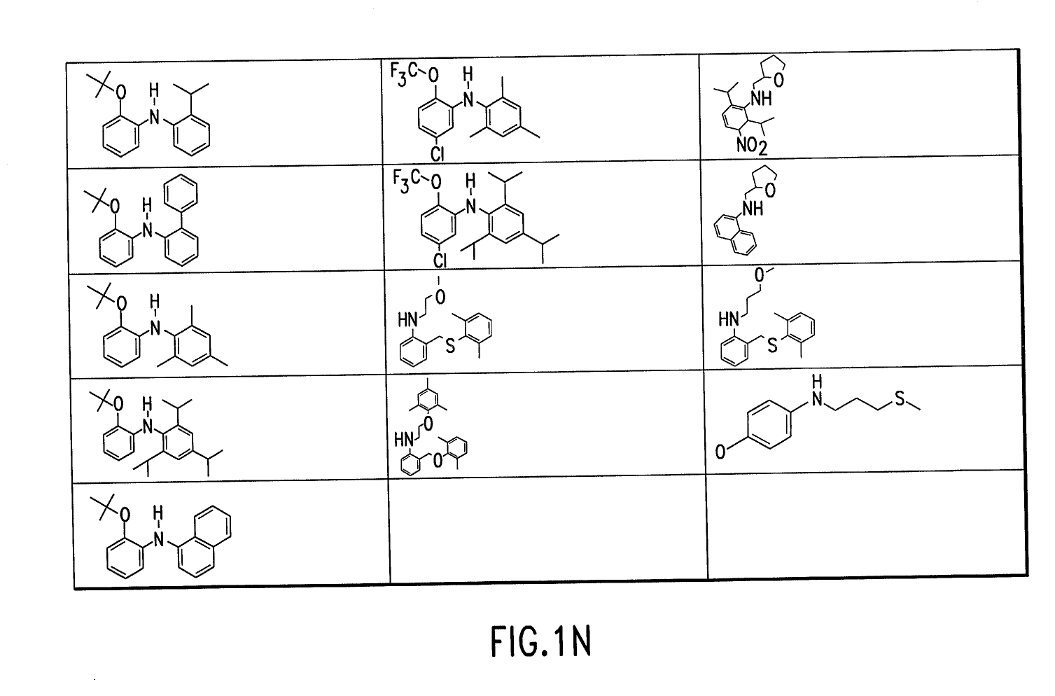

is intended to represents the situation where one or more of the hydrogen atoms on the ring can be substituted by R⁸. Since there may be up to 30 non-hydrogen atoms in the ring backbone, there may be one or more R⁸ groups on each of the non-hydrogen atoms in the ring, depending on the exact ring structure and the atoms in that ring structure. For example, if a carbon atom is in the ring, then there may be up to two R⁵ groups on the carbon. Also for example, if an oxygen atom is in the ring, then there will typically be no R⁸ groups on the oxygen. Two or more R⁸ groups may be joined to form a cyclic, bicyclic or multi-ring structure. More specific groups for R⁶, R⁷ and R⁸ can be found in the definitions, above. Specific examples of ligands useful in this invention are illustrated in FIGS. 1A-1E.

In one embodiment, preferred ligands of the invention include compounds of formula (VI):

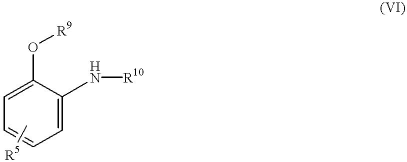

wherein R⁵ is as previously defined (preferably, alkyl, substituted alkyl, chloro or fluoro, or not present); R⁹ is alkyl, substituted alkyl, aryl or substituted aryl; and R¹⁰ is aryl, substituted aryl, substituted alkyl, arylalkyl, heteroarylalkyl, and substituted heteroarylalkyl.

In another embodiment, preferred ligands of the invention include compounds of formula (VII):

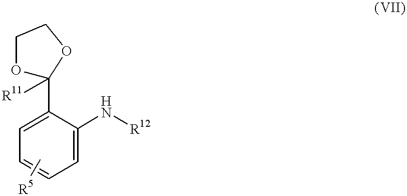

wherein R⁵ is as defined above (preferably, R⁵ is not present); R¹¹ is aryl or substituted aryl; and R¹² is hydrogen or alkyl.

In still another embodiment, preferred ligands of the invention include compounds of formula (VIII):

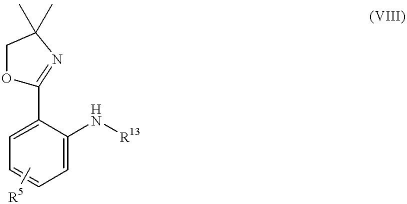

wherein R⁵ is as defined above (preferably, R⁵ is not present); and R¹³ is substituted alkyl, aryl, substituted aryl.

In still another embodiment, preferred ligands of the invention include compounds of formula (IX):

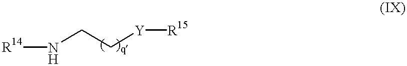

wherein q′ is 1 or 2; Y is S or O; R¹⁴ is aryl or substituted aryl; and R¹⁵ is alkyl, aryl or substituted aryl.

In still another embodiment, preferred ligands of the invention include compounds of formula (X):

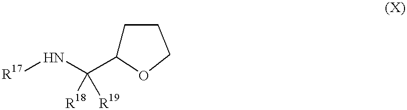

wherein R¹⁷ is aryl or substituted aryl; and R¹⁷ and R¹⁸ are independently hydrogen, alkyl, substituted alkyl or aryl.

In still another embodiment, preferred ligands of the invention include compounds of formula (XI):

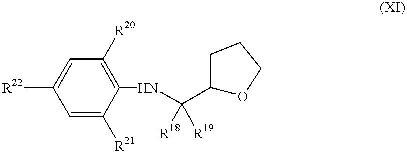

wherein R¹⁸ R¹⁹ are as previously defined in formula (X); and R²⁰, R²¹ , R²² are alkyl, substituted alkyl, aryl, substituted aryl or hydrogen.

Preferred embodiments are those compounds according to formula (XI) in which R¹⁸ and R¹⁹ are hydrogen and/or either (i) R²⁰ , R²¹ are other than hydrogen (preferably, alkyl) or (ii) R²² is hydrogen and R²⁰and R²¹ are other than hydrogen (preferably, alkyl). Specific ligands according to formula XI are provided in FIG. 1 and the working examples (e.g., ligands 4, 5 and 6).

The ligands of the invention may be prepared using known procedures. See, for example, Advanced Organic Chemistry, March, Wiley, New York 1992 (4^{th} Ed.).

Once the desired ligand is formed, it may be combined with a metal atom, ion, compound or other metal precursor compound. In some applications, the ligands of this invention will be combined with such a metal compound or precursor and the product of such combination is not determined, if a product forms. For example, the ligand may be added to a reaction vessel at the same time as the metal or metal precursor compound along with the reactants, activators, scavengers, etc. Additionally, the ligand can be modified prior to addition to or after the addition of the metal precursor, e.g. through a deprotonation reaction or some other modification.

The metal precursor compounds may be characterized by the general formula M(L)ₙ where M is a metal selected from Groups 3, 4 and the lanthanides and n is an integer that depends on the valence and/or oxidation state of the metal as well as the ligands L chosen for the metal precursor compound, e.g. such as whether the ligands L chosen for the metal precursor compounds are charged or neutral, bulky or less bulky. Generally, L is independently selected from the group consisting of halide (F, Cl, Br, I), alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, carboxylates, thio, 1,3-dionates, oxalates, carbonates, nitrates, sulphates, and combinations thereof. n is 1, 2, 3, 4, 5, 6, 7, 8, or 9. The metal precursors may be monomeric, dimeric or higher orders thereof.

In more specific embodiments M is chosen from Ti, Hf, Zr, Y, Nd and Er. In other embodiments M is chosen from Ti, Hf, Y, Nd and Er. In still other embodiments M is chosen from Hf, Nd and Er. In yet another embodiment, M is Hf. In those embodiments that use Hf, the metal should consist essentially of Hf. Preferably, the hafnium is about 90% or more pure, more preferably, the hafnium is about 95% or more pure, even more preferably, the hafnium is about 99% or more pure and most preferably, the hafnium is about 99.95% or more pure with respect to the hafnium metal. In a preferred embodiment, hafnium tetrachloride purchased from Strem Chemicals, Inc., (Newburyport, Mass.) is the source of hafnium.

In some embodiments where R¹ and X are joined together in a ring structure, M is not zirconium. In a specific embodiment, where R¹ and X are joined together in a ring structure (e.g, the ligand is a compound according to compound X), M is hafnium. Specific examples of suitable metal precursors include, but are not limited to Ti(CH₂Ph)₄, Zr(CH₂Ph)₄, Hf(CH₂Ph)₄, Sc(CH(SiMe₃)₂)₃, Y(CH(SiMe₃)₂)₃, Ln(CH(SiMe₃)₂)₃, Sc(O(2,6-(tBu)₂C₆H₃))₃, Y(O(2,6-(tBu)₂C₆H₃))₃, Ln(O(2,6-(tBu)₂C₆H₃))₃, Sc(O(2,6-(tBu)₂-4-Me-C₆H₃))₃, Y(O(2,6-(tBu)₂-4-Me-C₆H₃))₃, Ln(O(2,6-(tBu)₂-4-Me-C₆H3))₃, Sc(N(SiMe₃)₂)₃ Y(N(SiMe₃)₂)₃, Ln(N(SiMe₃)₂)₃, (where lanthanide or Ln=La, Ce, Pr, Nd, Sm, Eu, Gd, Tb, Dy, Ho, Er, Tm, Yb, and Lu), Ti(CH₂CMe₃)₄, Zr(CH₂CMe₃)₄, Hf(CH₂CMe₃)₄, TiCl₄, HfCl₄, Ti(NMe₂)₄, Zr(NMe₂)₄, Hf(NMe₂)₄, Zr(NEt₂)₄, Ti(NMe₂)₂Cl₂, Zr(N(SiMe₃)₂)₂Cl₂, Hf(N(SiMe₃)₂)₂Cl₂, Zr(TFA)₄, Hf(TFA)₄, Ti(TFA)₂Cl₂, TiCl₃(THF)₃. In this context, the ligand to metal precursor compound ratio is in the range of about 0.01:1 to about 100:1, more preferably in the range of about 0.1:1 to about 10:1.

In other applications, the ligand will be mixed with a suitable metal precursor compound prior to or simultaneously with allowing the mixture to be contacted with the reactants. When the ligand is mixed with the metal precursor compound, a metal ligand complex may be formed, which may be a catalyst. Depending on the substituents chosen for the ligand prior to reaction with the metal precursor compound, the metal ligand complexes may be characterized by the following general formula:

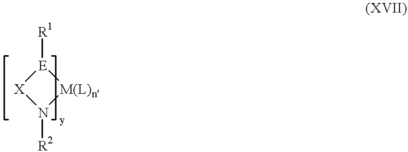

wherein M, L, E, R₁ , R₂ and X are as defined previously; y is an integer which depends upon the metal and the chosen substituents for E, R¹, R² and X. When M is a Group 3 or lanthanide metal, y may take the values 1 or 2; and when M is a Group 4 metal, y may take the values 1, 2, or 3. Generally, n′ is 1, 2, 3, 4, 5 or 6.

In one embodiment, the metal ligand complexes of the invention do not include any complex disclosed in Murray, U.S. Pat. No. 6,103,657 in which the metal is zirconium.

In another embodiment, the metal ligand complexes do not include complexes disclosed in Murray, U.S. Pat. No., 6,103,657 in which the metal is a Group 4 element other than hafnium.

In yet another embodiment embodiment, the metal ligand complexes of the invention do not include any complex represented by formula (XVIII) shown below:

[chemical structure]

wherein X′, Y′, Cyclo, R^{1′}, R^{2′}, Q′ and m are as previously described in formulae (IIa) and (Iib); p is an integer from 1 to 4; M′ is a metal selected from the group consisting of Group 3 to 13 elements and the Lathanide series elements; and each L′ is monovalent, bivalent or trivalent anion.

In yet another embodiment, the metal complexes of the invention do not include any complex represented by formula (XVIII), above, where M′ is zirconium or a Group 4 element other than hafnium.

In still another embodiment, the complex is represented by formula (XXVII):

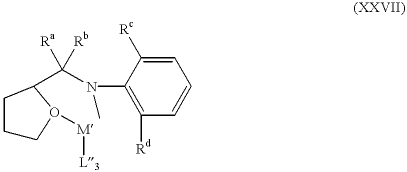

where R^{a}, R^{b}, R^{c}, R^{d} are as previously defined in Formula (XVI), each L″ is a monovalent, bivalent or trivalent anion and M′ is Zr ior a Group 4 element other than hafnium, is not a metal ligand complex of the current invention.

In still another embodiment, the metal ligand complexes do not include any complex represented by formula (XVII) shown above where X′ is N and Q′ is CR³ R⁴ where R³ and R⁴ are as previously defined.

In still another embodiment, when the metal ligand complex of the invention is a compound according to formula (XVII), M is hafnium.

In still another embodiment, when R¹ and X are joined together in a ring structure, M is not zirconium. In a specific embodiment when R¹ and X are joined together in a ring structure, M is hafnium. In another specific embodiment, when the complex is represented by by formula (XXVII) then M′ is hafnium.

Those of skill in the art will appreciate that in certain circumstances, the metal precursor used to make the metal ligand complexes of the invention may not be 100% pure with respect to the metal. In a preferred embodiment, the metal ligand complexes of the invention are in the form of compositions that are substantially pure with respect to the metal. Such substantially pure compositions may be obtained through the use of metal precursors that 90% or greater, 95% or greater, 99% or greater or even 99.95% or greater pure with respect to the metal.

In a preferred embodiment, the metal ligand complexes of this invention may be characterized by the following formulae:

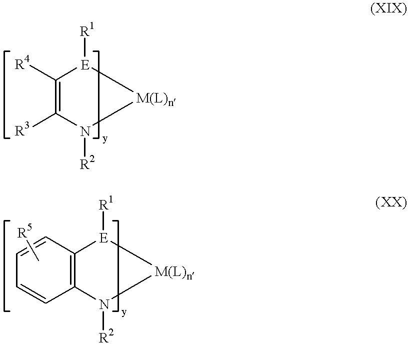

wherein M, L, E, R¹, R², R³, R⁴, and R⁵ are as defined previously; and n′ is 1, 2, 3, 4, 5 or 6. The substitution depicted for R⁵, i.e.,

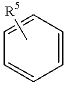

represents the situation where one or more of the hydrogen atoms on the benzene ring can be substituted by one or more R⁵, which may be the same or different. Two or more R⁵ groups may be joined to form a ring fused to the benzene ring e.g. generating a naphthyl or anthracenyl group. Also, y is an integer, which depends upon the metal and the substituents E, R¹, R¹, R¹, R¹, and/or R¹ chosen. When M is a Group 3 or lanthanide metal, y may take the values 1 or 2; when M is a Group 4 metal, y may take the values 1, 2, or 3.

In another preferred embodiment the metal ligand complexes of the invention may be characterized by the formula:

[chemical structure]

where M is hafnium and L, E, R 2, R⁶, R¹ and R⁸ are as defined previously; n′ is 1, 2, 3, 4, 5 or 6; and y is 1, 2 or 3. The ring structure

[chemical structure]

represents a ring structure made up from between 3-30 non hydrogen atoms as part of the backbone of the ring. In the context of formula I, above, this ring structure represents the optional combination of R¹ and X together in a ring structure. Specific examples of R¹ and X together are dimethylene (giving a three membered ring, trimethylene (giving a four membered ring), tetramethylene (giving a five membered ring, such as a tetrahydrofuran where E═O, or a tetrahydrothiophen where E═S), 3-oxopentylene (giving a six membered ring) and the like. The bridge may also be unsaturated such as in the case where E═O and the bridge generates a furan ring. The substitution for the ring structure

[chemical structure]

represents the situation where one or more of the hydrogen atoms on the ring can be substituted by one or more R⁸ groups, which may be the same or different. Since there may be up to 30 non-hydrogen atoms in the ring, there may be one or more R⁸ groups on each of the non-hydrogen atoms in the ring. For example, if a carbon atom is in the ring, then there may be up to two R⁸ groups on the carbon. Also for example, if an oxygen atom is in the ring, then there will typically be no R⁸ groups on the oxygen. Two or more R⁸ groups may be joined to form a ring structure, as described above.

In one embodiment, preferred complexes of the invention include complexes of formula (XXX):

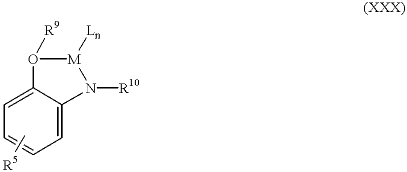

wherein R⁵ is as previously defined (preferably, alkyl, substituted alkyl, chloro or fluoro or not present); R⁹ is alkyl, substituted alkyl, aryl or substituted aryl; R¹⁰ is aryl, substituted aryl, substituted alkyl arylalkyl, heteroarylalkyl and substituted heteroarylalkyl; and M, L and n are as previously defined.

In another embodiment, preferred complexes of the invention include complexes of formula (XXXI):

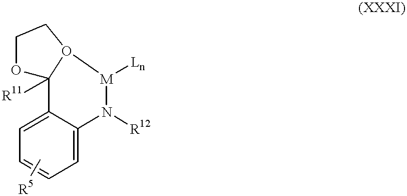

wherein R⁵ is as previously defined (preferably, R⁵ is not present; R¹¹ is aryl or substituted aryl; R¹² is hydrogen or alkyl; and M, L and n are as previously defined.

In still another embodiment, preferred complexes of the invention include complexes of formula (XXXII):

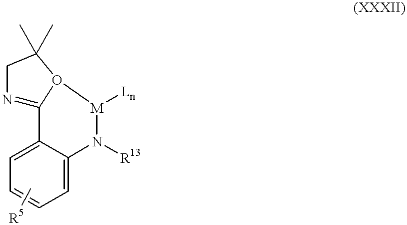

wherein R⁵ is as defined above in Formula VI (preferably, R¹¹ is hydrogen); R¹³ is substituted alkyl, aryl, substituted aryl; and M, L and n are as previously defined.

In still another embodiment, preferred complexes of the invention include complexes of formula (XXXIII):

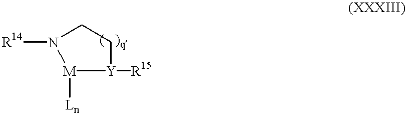

wherein q′ is 1 or 2; Y is S or O; R¹⁴ is aryl or substituted aryl; R¹⁵ is alkyl, aryl or substituted aryl; and M, L and n are as previously defined.

In still another embodiment, preferred complexes of the invention include complexes of formula (XXXIV):

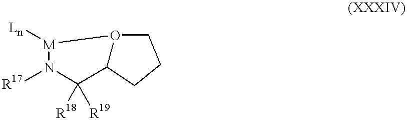

wherein R¹⁷ is aryl or substituted aryl; R¹⁷ and R¹⁸ are independently hydrogen, alkyl, substituted alkyl or aryl; and M, L and n are as previously defined.

In still another embodiment, preferred complexes of the invention include complexes of formula (XXXV):

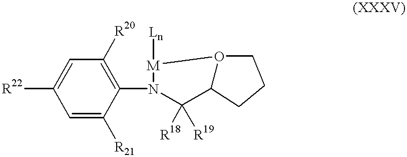

wherein R¹⁸, R¹⁹ are as previously defined in formula (X); R²⁰, R²¹, R²² are alkyl, substituted alkyl, aryl or hydrogen; and M, L and n are as previously defined.

In another embodiment, preferred complexes according to formulae (XIX), (XX), (XXX), (XXXI), (XXXII), (XXXIII), (XXXIV), and (XXXV) are those in which M is hafnium.

In many of the formulas herein (particularly formulas XXX through XXXV) the bond between M and o is a dative bond. This has not been drawn as an arrow or with other special notations for convenience only and should not be taken as a statement regarding the nature of the complex.

Within these formulae, specific examples of metal ligand complexes include, but are not limited to:

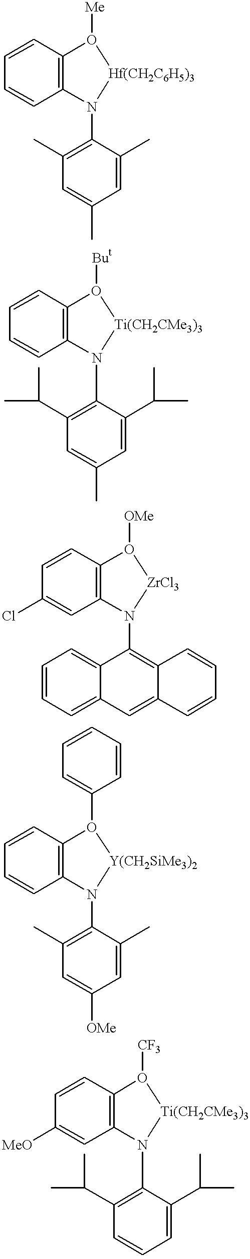

Various references disclose metal complexes that may appear to be similar; see for example, WO 99/01460 and EP 0 950 667 A2, both of which are incorporated herein by reference for all purposes. However, the specific embodiments of the invention herein provide improved polymerization performance (e.g., higher activity and/or higher polymerization temperatures) relative to the specific embodiments disclosed in those references.

For example, as will be described in more detail in the working examples, it has been discovered that the catalytic performance of metal ligand complexes of the invention prepared from ligands 4, 5 and 6 in which the metal is hafnium is surprisingly superior to the corresponding complexes in which the metal is zirconium. Moreover, the yields of copolymers obtained with these hafnium complexes are dramatically enhanced as well. As a consequence in certain embodiments of the metal ligand complexes of the invention the metal is hafnium. Preferably, the metal complex is substantially pure with respect to hafnium as previously described.

Polymerization Activators/Additives

The metal ligand complexes and compositions are active catalysts typically in combination with a suitable activator or activating technique, although some of the group 3 metal complexes may be active without an activator or activating technique. Broadly, the activator may comprise alumoxanes, Lewis acids, Bronsted acids, compatible non-interfering activators and combinations of the foregoing. These types of activators have been taught for use with different compositions or metal complexes in the following references, which are hereby incorporated by reference in their entirety: U.S. Pat. Nos. 5,599,761, 5,616,664, 5,453,410, 5,153,157, 5,064,802, and EP-A-277,004. In particular, ionic or ion forming activators are preferred.

Suitable ion forming compounds useful as an activator in one embodiment of the present invention comprise a cation that is a Bronsted acid capable of donating a proton, and an inert, compatible, non-interfering, anion, A-. Preferred anions are those containing a single coordination complex comprising a charge-bearing metal or metalloid core. Mechanistically, said anion should be sufficiently labile to be displaced by olefinic, diolefinic and acetylenically unsaturated compounds or other neutral Lewis bases such as ethers or nitrites. Suitable metals include, but are not limited to, aluminum, gold and platinum. Suitable metalloids include, but are not limited to, boron, phosphorus, and silicon. Compounds containing anions that comprise coordination complexes containing a single metal or metalloid atom are, of course, well known and many, particularly such compounds containing a single boron atom in the anion portion, are available commercially.

Preferably such activators may be represented by the following general formula:

(L*—H)_{d}⁺(A^{d-})

wherein, L* is a neutral Lewis base; (L*—H)⁺ is a Bronsted acid; A^{d-} is a non-interfering, compatible anion having a charge of d−, and d is an integer from 1 to 3. More preferably A^{d-} corresponds to the formula: [M′³⁺ Qₕ]^{d-} wherein h is an integer from 4 to 6; h−3=d; M′ is an element selected from Group 13 of the Periodic Table of the Elements; and Q is independently selected from the group consisting of hydride, dialkylamido, halide, alkoxide, aryloxide, hydrocarbyl, and substituted-hydrocarbyl radicals (including halosubstituted hydrocarbyl, such as perhalogenated hydrocarbyl radicals), said Q having up to 20 carbons. In a more preferred embodiment, d is one, i.e., the counter ion has a single negative charge and corresponds to the formula A⁻.

Activators comprising boron or aluminum which are particularly useful in the preparation of catalysts of this invention may be represented by the following general formula:

[L*—H]⁺[JQ₄]⁻

wherein: L* is as previously defined; J is boron or aluminum; and Q is a fluorinated C₁₋₂₀ hydrocarbyl group. Most preferably, Q is independently selected from the group selected from the group consisting of fluorinated aryl group, especially, a pentafluorophenyl group (i.e., a C₆F₅ group) or a 3,5-bis(CF₃)₂C₆H₃ group. Illustrative, but not limiting, examples of boron compounds which may be used as an activating cocatalyst in the preparation of the improved catalysts of this invention are tri-substituted ammonium salts such as: trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethylanilinium tetra-(3,5-bis(trifluoromethyl)phenyl)borate, N,N-dimethyl-(2,4,6-trimethylanilinium) tetraphenylborate, trimethylammonium tetrakis(pentafluorophenyl) borate, triethylammonium tetrakis(pentafluorophenyl) borate, tripropylammonium tetrakis(pentafluorophenyl) borate, tri(n-butyl)ammonium tetrakis(pentafluorophenyl) borate, tri(secbutyl)ammonium tetrakis(pentafluorophenyl) borate, N,N-dimethylanilinium tetrakis(pentafluorophenyl) borate, N,N-diethylanilinium tetrakis(pentafluorophenyl) borate, N,N-dimethyl-(2,4,6-trimethylanilinium) tetrakis(pentafluorophenyl) borate, trimethylammonium tetrakis-(2,3,4,6-tetrafluorophenylborate and N,N-dimethylanilinium tetrakis-(2,3,4,6-tetrafluorophenyl) borate; dialkyl ammonium salts such as: di-(i-propyl)ammonium tetrakis(pentafluorophenyl) borate, and dicyclohexylammonium tetrakis(pentafluorophenyl) borate; and tri-substituted phosphonium salts such as: triphenylphospnonium tetrakis(pentafluorophenyl) borate, tri(o-tolyl)phosphonium tetrakis(pentafluorophenyl) borate, and tri(2,6-dimethylphenyl)phosphonium tetrakis(pentafluorophenyl) borate; and N,N-dimethylanilinium tetrakis(3,5-bis(trifluoromethyl)phenyl)borate. Preferred [L*—H]⁺ cations are N,N-dimethylanilinium and tributylammonium. Preferred anions are tetrakis(3,5-bis(trifluoromethyl)phenyl)borate and tetrakis(pentafluorophenyl)borate. In some embodiments, the most preferred activator is PhNMe₂H⁺B(C₆F₅)₄⁻.

Other suitable ion forming activators comprise a salt of a cationic oxidizing agent and a non-interfering, compatible anion represented by the formula:

(Ox^{e+})_{d}(A^{d-})ₑ

wherein: Ox^{e+} is a cationic oxidizing agent having a charge of e+; e is an integer from 1 to 3; and A^{d-}, and d are as previously defined. Examples of cationic oxidizing agents include: ferrocenium, hydrocarbyl-substituted ferrocenium, Ag⁺, or Pb⁺². Preferred embodiments of A^{d-} are those anions previously defined with respect to the Bronsted acid containing activating cocatalysts, especially tetrakis(pentafluorophenyl)borate.

Another suitable ion forming, activating cocatalyst comprises a compound which is a salt of a carbenium ion or silyl cation and a non-interfering, compatible anion represented by the formula:

©⁺A⁻

wherein: ©⁺ is a C₁₋₁₀₀ carbenium ion or silyl cation; and A⁻ is as previously defined. A preferred carbenium ion is the trityl cation, i.e. triphenylcarbenium. The silyl cation may be characterized by the formula Z¹Z²Z³Si⁺ cation, where each of Z¹, Z², and Z³ is independently selected from the group consisting of alkyl, substituted alkyl, cycloalkyl, heterocycloalkyl, heterocyclic, aryl, substituted aryl, heteroaryl, substituted heteroaryl and combinations thereof. In some embodiments, a most preferred activator is Ph₃C⁺B(C₆F₅)₄⁻.

In addition, suitable activators include Lewis acids, such as those selected from the group consisting of tris(aryl)boranes, tris(substituted aryl)boranes, tris(aryl)alanes, tris(substituted aryl)alanes, including activators such as tris(pentafluorophenyl)borane. Other useful ion forming Lewis acids include those having two or more Lewis acidic sites, such as those described in WO 99/06413 or Piers, et al. “New Bifunctional Perfluoroaryl Boranes: Synthesis and Reactivity of the ortho-Phenylene-Bridged Diboranes 1,2-[B(C₆F₅)₂]₂C₆X₄ (X═H, F)”, J. Am. Chem. Soc., 1999, 121, 3244-3245, both of which are incorporated herein by reference. Other useful Lewis acids will be evident to those of skill in the art. In general, the group of Lewis acid activators are within the group of ion forming activators (although exceptions to this general rule can be found) and the group tends to exclude the group 13 reagents listed below. Combinations of ion forming activators may be used.

Other general activators or compounds useful in a polymerization reaction may be used. These compounds may be activators in some contexts, but may also serve other functions in the polymerization system, such as alkylating a metal center or scavenging impurities. These compounds are within the general definition of “activator,” but are not considered herein to be ion forming activators. These compounds include a group 13 reagent that may be characterized by the formula G¹³R′₃₋ₚDₚ where G¹³ is selected from the group consisting of Al, B, Ga, In and combinations thereof, p is 0, 1 or 2, each R′ is independently selected from the group consisting of alkyl, substituted alkyl, cycloalkyl, heterocycloalkyl, heterocyclic and combinations thereof, and each D is independently selected from the group consisting of halide, hydride, alkoxy, aryloxy, amino, thio, phosphino and combinations thereof. In other embodiments, the group 13 activator is an oligomeric or polymeric alumoxane compound, such as methylalumoxane and the known modifications thereof. In other embodiments, a divalent metal reagent may be used that is defined by the general formula M′R′_{2-p′}, D_{p′} and p′ is 0 or 1 in this embodiment and R′ and D are as defined above. M′ is the metal and is selected from the group consisting of Mg, Ca, Sr, Ba, Zn, Cd and combinations thereof. In still other embodiments, an alkali metal reagent may be used that is defined by the general formula M″R′ and in this embodiment R′ is as defined above. M″ is the alkali metal and is selected from the group consisting of Li, Na, K, Rb, Cs and combinations thereof. Additionally, hydrogen and/or silanes may be used in the catalytic composition or added to the polymerization system. Silanes may be characterized by the formula SiR′_{4-q}D_{q} where R′ is defined as above, q is 1, 2, 3 or 4 and D is as defined above, with the proviso that there is at least one D that is a hydride.

The molar ratio of metal:activator (whether a composition or complex is employed as a catalyst) employed preferably ranges from 1:10,000 to 100:1, more preferably from 1:5000 to 10:1, most preferably from 1:10 to 1:1. In a preferred embodiment of the invention mixtures of the above compounds are used, particularly a combination of a group 13 reagent and an ion-forming activator. The molar ratio of group 13 reagent to ion-forming activator is preferably from 1:10,000 to 1000:1, more preferably from 1:5000 to 100:1, most preferably from 1:100 to 100:1. In a preferred embodiment, the ion forming activators are combined with a tri-alkyl aluminum, specifically trimethylaluminum, triethylaluminum, or triisobutylaluminum or with a di-alkyl aluminum hydride such as di-isobutyl aluminum hydride. A most preferred combination is 2 equivalents of tris(perfluorophenyl)boron and 5 equivalents of tri(isobutyl)aluminum.

In other applications, the ligand will be mixed with a suitable metal precursor compound prior to or simultaneous with allowing the mixture to be contacted to the reactants. When the ligand is mixed with the metal precursor compound, a metal ligand complex may be formed, which may be a catalyst. In connection with the metal ligand complex and depending on the ligand or ligands chosen, the metal ligand complex may take the form of dimers, trimers or higher orders thereof or there may be two or more metal atoms that are bridged by one or more ligands. Furthermore, two or more ligands may coordinate with a single metal atom. The exact nature of the metal ligand complex(es) or compound(s) formed depends on the chemistry of the ligand and the method of combining the metal precursor and ligand, such that a distribution of metal ligand complexes may form with the number of ligands bound to the metal being greater or less than the number of equivalents of ligands added relative to an equivalent of metal precursor.

The ligands may be supported, with or without the metal coordinated, on an organic or inorganic support. Suitable supports include silicas, aluminas, clays, zeolites, magnesium chloride, polyethyleneglycols, polystyrenes, polyesters, polyamides, peptides and the like. Polymeric supports may be cross-linked or not. Similarly, the metal may be supported with or without the ligand, on similar supports known to those of skill in the art.

Monomers/Polymers

The compositions and catalysts herein may be used to polymerize olefinically or acetylenically unsaturated monomers having from 2 to 20 carbon atoms either alone or in combination. The compounds and catalysts of this invention may also usefully polymerize functionalized monomers. Monomers include olefins, diolefins and acetylenically unsaturated monomers including ethylene and C₃ to C₂₀ α-olefins such as propylene, 1-butene, 1-hexene, 1-octene, 4-methyl-1-pentene, 1-norbomene, styrene and mixtures thereof; additionally, 1,1-disubstituted olefins, such as isobutylene, either alone or with other monomers such as ethylene or C₃ to C₂₀ α-olefins and/or diolefins. These definitions are intended to include cyclic olefins. Diolefins generally comprise 1,3-dienes such as (butadiene), substituted 1,3-dienes (such as isoprene) and other substituted 1,3-dienes, with the term substituted referring to the same types of substituents referred to above in the definition section. Diolefins also comprises 1,5-dienes and other non-conjugated dienes. The styrene monomers may be unsubstituted or substituted at one or more positions on the aryl ring. The use of diolefins in this invention is typically in conjunction with another monomer that is not a diolefin.

More specifically, it has been found that the catalysts of the present invention are particularly active for certain monomers, particularly α-olefins that have a chain length of C₄ or higher. Thus, the catalysts of the present invention may provide higher comonomer incorporation for copolymers of ethylene and co-monomers having four or more carbon atoms. In addition, the catalysts of the present invention may polymerize vinyl chloride alone (e.g., in a homopolymerization) or with other monomers (such as ethylene or C₃ to C₂₀ α-olefins). Furthermore, vinyl monomers with functional groups may also be polymerized alone (e.g., in a homopolymerization) or with other monomers (such as ethylene or C₃ to C₂₀ α-olefins). Such functional group containing vinyl monomers can be characterized by the general formula H₂C═CH—FG, where FG is the functional group that contains at least one heteroatom (using the previous definition) or halogen (e.g., Cl, F, Br, etc.). Functional monomers include C₁-C₂₀ acrylates, C₁-C₂₀ methacrylates, C₁-C₂₀ vinylacetates, acrylic acid, methacrylic acid, maleic anhydride, vinyl acetate, vinyl ethers, acrylonitrile, acrylamide, vinyl chloride and mixtures thereof.

Novel polymers, copolymers or interpolymers may be formed having unique physical and/or melt flow properties. Such novel polymers can be employed alone or with other polymers in a blend to form products that may be molded, cast, extruded or spun. End uses for the polymers made with the catalysts of this invention include films for packaging, trash bags, bottles, containers, foams, coatings, insulating devices and household items. Also, such functionalized polymers are useful as solid supports for organometallic or chemical synthesis processes.

Polymerization Systems

Polymerization can be carried out in the Ziegler-Natta or Kaminsky-Sinn methodology, including temperatures of from −100° C. to 300° C. and pressures from atmospheric to 3000 atmospheres. Suspension, solution, slurry, gas phase or high-pressure polymerization processes may be employed with the catalysts and compounds of this invention. Such processes can be run in a batch, semi-batch or continuous mode. Examples of such processes are well known in the art. A support for the catalyst may be employed, which may be inorganic (such as alumina, magnesium chloride or silica) or organic (such as a polymer or cross-linked polymer). Methods for the preparation of supported catalysts are known in the art. Slurry, suspension, solution and high-pressure processes as known to those skilled in the art may also be used.

Suitable solvents for polymerization are noncoordinating, inert liquids. Examples include straight and branched-chain hydrocarbons such as isobutane, butane, pentane, isopentane, hexane, isohexane, heptane, octane, Isopar-E® and mixtures thereof; cyclic and alicyclic hydrocarbons such as cyclohexane, cycloheptane, methylcyclohexane, methylcycloheptane, and mixtures thereof; perhalogenated hydrocarbons such as perfluorinated C₄₋₁₀ alkanes, chlorobenzene, and aromatic and alkylsubstituted aromatic compounds such as benzene, toluene, mesitylene, and xylene. Suitable solvents also include liquid olefins which may act as monomers or comonomers including ethylene, propylene, 1-butene, butadiene, cyclopentene, 1-hexene, 1-pentene, 3-methyl-1-pentene, 4-methyl-1-pentene, 1,4-hexadiene, 1-octene, 1-decene, isobutylene, styrene, divinylbenzene, allylbenzene, vinyltoluene (including all isomers alone or in admixture), vinyl chloride, acrylonitrile, acrylates, vinyl acetate, methacrylates, 4-vinylcyclohexene, and vinylcyclohexane. Mixtures of the foregoing are also suitable.

Other additives that are useful in a polymerization reaction may be employed, such as scavengers, promoters, etc.

Combinatorial Methodology

The ligands, metal ligand complexes and compositions of this invention can be prepared and tested for catalytic activity in one or more of the above reactions in a combinatorial fashion. Combinatorial chemistry generally involves the parallel or rapid serial synthesis and/or screening or characterization of compounds and compositions of matter. U.S. Pat. Nos. 5,985,356, 6,030,917 and WO 98/03521, all of which are incorporated herein by reference, generally disclose combinatorial methods. In this regard, the ligands, metal ligand complexes or compositions may be prepared and/or tested in rapid serial and/or parallel fashion, e.g., in an array format. When prepared in an array format, ligands, metal ligand complexes or compositions may be take the form of an array comprising a plurality of compounds wherein each compound can be characterized by any of the general formulae described above (i.e., I, III-XI, XVII, XIX-XXI, XXX-XXXV). In some embodiments, at least some of the compounds in the plurality will be characterized by the general formula:

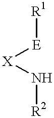

wherein E, X, R¹ and R² are as previously described. The array may also be of metal precursor compounds, the metal-ligand complexes or compositions characterized by the previously described formulaeand/or description. Typically, each member of the array will have differences so that, for example, a ligand or activator or metal precursor or R group in a first region of the array may be different than the ligand or activator or metal precursor or R group in a second region of the array. Other variables may also differ from region to region in the array.

In such a combinatorial array, typically each of the plurality of compositions or complexes has a different composition or stoichiometry, and typically each composition or complex is at a selected region on a substrate such that each compound is isolated from the other compositions or complexes. This isolation can take many forms, typically depending on the substrate used. If a flat substrate is used, there may simply be sufficient space between regions so that there cannot be interdiffusion between compositions or complexes. As another example, the substrate can be a microtiter or similar plate having wells so that each composition or complex is in a region separated from other compounds in other regions by a physical barrier. The array may also comprise a parallel reactor or testing chamber.

The array typically comprises at least 8 compounds, complexes or compositions each having a different chemical formula, meaning that there must be at least one different atom or bond differentiating the members in the array or different ratios of the components referred to herein (with components referring to ligands, metal precursors, activators, group 13 reagents, solvents, monomers, supports, etc.). In other embodiments, there are at least 20 compounds, complexes or compositions on or in the substrate each having a different chemical formula. In still other embodiments, there are at least 40 or 90 or 124 compounds, complexes or compositions on or in the substrate each having a different chemical formula. Because of the manner of forming combinatorial arrays, it may be that each compound, complex or composition may not be worked-up, purified or isolated, and for example, may contain reaction by-products or impurities or unreacted starting materials.

The catalytic performance of the compounds, complexes or compositions of this invention can be tested in a combinatorial or high throughput fashion. Polymerizations can also be performed in a combinatorial fashion, see, e.g., U.S. patent application Ser. Nos. 09/211,982, filed Dec. 14, 1998, Ser. No. 09/239,223, filed Jan. 29, 1999, or Ser. No. 09/548,848, filed Apr. 13, 2000 each of which is herein incorporated by reference.

### EXAMPLES

General:

All reactions were performed under a purified argon or nitrogen atmosphere in a Vacuum Atmospheres glove box. All solvents used were of the anhydrous, de-oxygenated and purified according to known techniques. All ligands and metal precursors were prepared according to procedures known to those of skill in the art, e.g., under inert conditions, etc. Polymerizations were carried out in a parallel pressure reactor, which is fully described in pending U.S. patent applications Ser. Nos. 09/177,170, filed Oct. 22, 1998, Ser. No. 09/211,982, filed Dec. 14, 1998, Ser. No. 09/239,223, filed Jan. 29, 1999, and WO 00/09255, each of which is incorporated herein by reference.

High temperature Size Exclusion Chromatography was performed using an automated “Rapid GPC” system as described in U.S. patent application Ser. Nos. 09/285,363; 09/285,333; 09/285,335 now U.S. Pat. No. 6,175,409; or 09/285,392; each of which was filed on Apr. 2, 1999 and each of which is incorporated herein by reference. In the current apparatus, a series of two 30 cm×7.5 mm linear columns, with one column containing PLgel 10 um, MixB and the other column containing PLgel 5 um, MixC. The columns were calibrated using narrow polystyrene standards. A flow rate of 1.5 mL/min. was used, with an injection volume of 40 μL of a polymer solution with a concentration of about 1 mg/mL, an oven temperature of 160° C., and the polymer samples dissolved in o-dichlorobenzene. The concentration of the polymer in the eluent was monitored using an evaporative light scattering detector. All of the molecular weight results obtained are relative to linear polystyrene standards.

FTIR was performed on a Bruker Equinox 55+IR Scope II in reflection mode with 16 scans, to determine the ratio of 1-octene to ethylene incorporated in the polymer product, represented as the weight % (wt. %) of 1-octene incorporated in the polymer (wt. % 1-octene). Wt.% 1-octene was obtained from ratio of peak heights at 1378 cm⁻¹ and 4335 cm⁻¹. This method was calibrated using a set of ethylene/1-octene copolymers with a range of known wt. % 1-octene content.

### Example 1.0

### Ethylene/1-Octene Copolymerizations using Metal-Ligand Compositions

Preparation of the Polymerization Reactor Prior to Injection of Catalyst Composition:

A pre-weighed glass vial insert and disposable stirring paddle were fitted to each reaction vessel of the reactor. The reactor was then closed, and 0.10 mL of 0.02 M TIBA (triisobutylaluminum), 0.25 mL of 1-octene, and 4.75 mL of toluene was injected into each reaction vessel through a valve. The temperature was then set to 130° C., the stirring speed was set to 600 rpm, and the toluene/1-octene mixture was exposed to ethylene gas at 100 psi pressure. An ethylene pressure of 100 psi in the pressure cell and the temperature setting were maintained, using computer control, until the end of the polymerization experiment.

Preparation of Stock Solutions:

The “group 13 reagent solution” is a 0.2 M solution of TIBA. The “activator solution” is a 10 mM solution of N,N′-dimethylanilinium tetrakis(pentafluorophenyl)borate in toluene, heated to approximately 85° C. to fully dissolve the N,N′-dimethylanilinium tetrakis(pentafluorophenyl)borate.

In situ Preparation of Metal Ligand Compositions:

Stock solutions were prepared as follows: The “metal precursor solution” is a 25 mM solution of the metal precursor in toluene. The “ligand solutions” are 25 mM solutions of the respective ligands in toluene, prepared in an array of 1 mL glass vials by adding 0.06 mL of toluene to 1.5 μmol of the ligand in a 1 mL glass vial. To each 1 mL glass vial containing ligand/toluene solution was added 0.060 mL of the metal precursor solution (1.5 μmol), to form the metal-ligand combination solutions. To each metal-ligand combination solution was then added 0.060 mL of a 0.5 M 1-octene solution in toluene (30 μmol of 1-octene). The resultant solutions were allowed to sit at room temperature for 1 hour prior to addition of TIBA solution and injection into the reactor, as described below.

Table 1 illustrates the ligands used:

TABLE 1

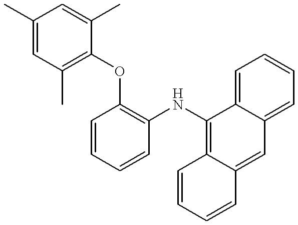

Ligand 1

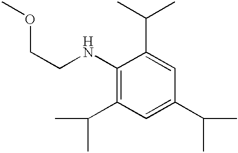

Ligand 2

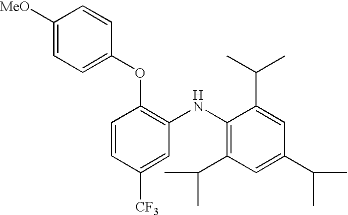

Ligand 3

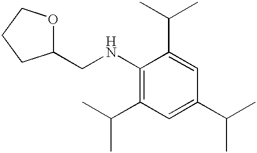

Ligand 4

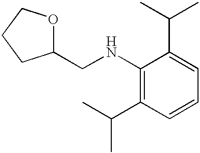

Ligand 5

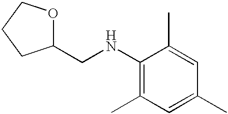

Ligand 6

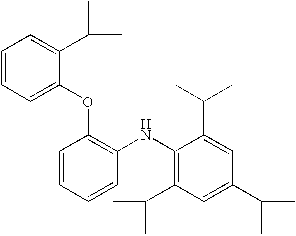

Ligand 7

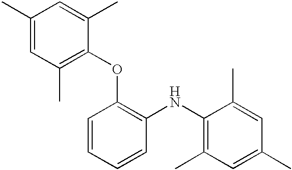

Ligand 8

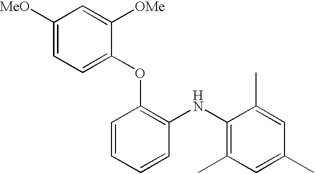

Ligand 9

Injection of solutions into the pressure reactor vessel:

After the toluene/1-octene mixture in the pressurized reactor was saturated with ethylene at 100 psi pressure, 0.075 mL (15 μmol) of the 0.2 M group 13 reagent solution was added to the 1 mL vial. About 30 seconds later, 0.100 mL (1 μmol) of the “activator solution” followed immediately by 0.400 mL of toluene, were injected into the pressurized reaction vessel. About another 30 seconds later, 0.170 mL of the 1 mL vial contents, followed immediately by 0.330 mL of toluene, were injected into the pressurized reaction vessel. Results are presented in Table 2. Comparative examples using ancillary ligands 4, 5 and 6 with Zr(CH₂C₆H₅)₄ as the metal precursor are presented in Table 3.

Polymerization:

The polymerization reactions were allowed to continue for 30 minutes, during which time the temperature and pressure were maintained at their pre-set levels (100 psi pressure, 130° C.) by computer control. After 30 minutes, the ethylene flow to the reactor vessel was stopped, the temperature was allowed to drop to about 80° C. and the ethylene pressure in the cell was slowly vented.

Product Work Up:

The glass vial insert, containing the polymer product and solvent, was then removed from the pressure cell and removed from the inert atmosphere dry box, and the volatile components were removed using a centrifuge vacuum evaporator. After most of the volatile components had evaporated, the vial contents were dried thoroughly by evaporation at elevated temperature under reduced pressure. The vial was then weighed to determine the yield of polymer product. The polymer product was then analyzed by rapid GPC, as described above to determine the molecular weight of the polymer produced, and by FTIR spectroscopy to determine the ratio of 1-octene to ethylene incorporated in the polymer product, represented as the weight % of 1-octene incorporated in the polymer.

TABLE 2
Results of the ethylene/1-octene copolymerizations using metal ligand
compositions

| | Metal | μmol | Yield | | | Wt. % |
|---|---|---|---|---|---|---|
| Ligand | Precursor | metal | (mg) | Mw/1000 | Mw/Mn | 1-Octene |
| 1 | Hf(CH₂C₆H₅)₄ | 1 | 126 | 58 | 2.3 | 20 |
| 2 | Hf(CH₂C₆H₅)₄ | 1 | 477 | 58 | 2.1 | 15 |
| 3 | Hf(CH₂C₆H₅)₄ | 1 | 344 | 75 | 2.0 | 15 |
| 4 | Hf(CH₂C₆H₅)₄ | 1 | 442 | 55 | 3.1 | 14 |
| 5 | Hf(CH₂C₆H₅)₄ | 1 | 482 | 49 | 3.1 | 12 |
| 6 | Hf(CF₂C₆H₅)₄ | 1 | 411 | 74 | 3.3 | 14 |
| 7 | Hf(CH₂C₆H₅)₄ | 1 | 202 | 106 | 2.3 | 14 |
| 8 | Hf(CH₂C₆H₅)₄ | 1 | 175 | 60 | 3.1 | 20 |
| 9 | Hf(CH₂C₆H₅)₄ | 1 | 142 | 46 | 2.6 | 20 |
| None | Hf(CH₂C₆H₅)₄ | 1 | 47 | 89 | 4.4 | 10 |

TABLE 3
Comparative examples of ethylene/1-octene copolymerizations using
zirconium tetrabenzyl metal precursor

| | Metal | μmol | Yield | | | Wt. % |
|---|---|---|---|---|---|---|
| Ligand | Precursor | metal | (mg) | Mw/1000 | Mw/Mn | 1-Octene |
| 4 | Zr(CH₂C₆H₅)₄ | 1 | 270 | 81 | 3.0 | 7 |
| 5 | Zr(CH₂C₆H₅)₄ | 1 | 278 | 69 | 2.7 | 6 |
| 6 | Zr(CH₂C₆H₅)₄ | 1 | 279 | 127 | 3.7 | 7 |
| None | Zr(CH₂C₆H₅)₄ | 1 | 369 | 69 | 2.2 | 7 |

As discussed herein, catalytic performance can be determined a number of different ways, as those of skill in the art will appreciate. Catalytic performance can be determined by the yield of polymer obtained per mole of metal complex, which in some contexts may be considered to be activity. Table 2 and Table 3 display the results of ethylene-1-octene copolymerizations using ancillary ligands of the invention in combination with hafnium and zirconium precursors, respectively. In the case of zirconium, Table 3 illustrates that the yield of copolymer obtained from the experiments is the highest when the zirconium precursor (Zr(CH₂C₆H₅)₄) is employed without the use of an ancillary ligand (369 mg). This illustrates that the presence of the ancillary ligand may not necessarily enhance the catalytic performance of the zirconium metal center. In contrast to Zirconium, the yield of copolymer obtained when the hafnium precursor (Hf(CH₂C₆H₅)₄) is employed without the use of an ancillary ligand is very low (47 mg).

Another measure of catalyst polymerization performance is co-monomer incorporation. As is well known in the art, many ethylene copolymers are prepared using ethylene and at least one other monomer. These copolymers or higher order polymers in some applications require higher amounts of additional co-monomer(s) than have been practical with known catalysts. Since ethylene tends to be the most reactive monomer, obtaining higher co-monomer incorporations is a benefit that is examined for polymerization catalysts. Two common co-monomers are 1-octene and 1-hexene. This invention offers the possibility of higher incorporation of co-monomers such as 1-octene and 1-hexene. As shown herein, the ethylene/1-octene copolymers obtained from the combination of ancillary ligands 4, 5 and 6 (See Table 1) with Zr(CH₂C₆H₅)₄ all possess lower weight % 1-octene values (<10 wt. %) (Table 3), than the weight % 1-octene values for the ethylene/1-octene copolymers obtained from the combination of ancillary ligands 4, 5 and 6 with Hf(CH₂C₆H₅)₄.

The results of the ethylene-1-octene copolymerizations using ancillary ligands 4, 5 and 6 of the invention in combination with a hafnium metal precursor are surprising (Table 2). In contrast to zirconium (Table 3), the yield of copolymer obtained when the hafnium precursor (Hf(CH₂C₆H₅)₄) is employed without the use of an ancillary ligand is very low (47 mg). Surprisingly, in the presence of certain ancillary ligands, the yields of copolymers obtained are enhanced dramatically. This result illustrates the ability of ancillary ligands of the invention to enhance the catalytic performance of the hafnium metal center. In addition, in the presence of these ancillary ligands the copolymers obtained typically possess higher wt. % 1-octene values relative to the values shown in Table 3. This result illustrates the ability of the ancillary ligand-hafnium metal precursor combinations to incorporate higher amounts of 1-octene into the copolymer. Additionally, Table 2 illustrates that the wt. % 1-octene values for the copolymers obtained span a wider range (10 wt. % to 20 wt. %). In contrast to the comparative examples in Table 3, the results in Table 2 illustrate the ability of the ancillary ligands to tailor the catalytic performance of the hafnium metal center, both in terms of catalytic activity and the ability to incorporate 1-octene into the copolymer.

### Example 1.1

### Propylene Polymerizations using Metal-ligand Compositions

Preparation of the Polymerization Reactor Prior to Injection of Catalyst Composition:

A pre-weighed glass vial insert and disposable stirring paddle were fitted to each reaction vessel of the reactor. The reactor was then closed, and 0.05 mL of 0.02 M TIBA (triisobutylaluminum), and 3900 mL of toluene was injected into each reaction vessel through a valve. The temperature was then set to 75° C., the stirring speed was set to 600 rpm, and the toluene/TIBA mixture was exposed to propylene gas at 100 psi pressure. A propylene pressure of 100 psi in the pressure cell and the temperature setting were maintained, using computer control, until the end of the polymerization experiment.

Preparation of Stock Solutions:

The “group 13 reagent solution” is a 0.05 M solution of TIBA. The “activator solution” is a 5 mM solution of N,N′-dimethylanilinium tetrakis(pentafluorophenyl)borate in toluene, heated to approximately 85° C. to fully dissolve the N,N′-dimethylanilinium tetrakis(pentafluorophenyl)borate.

In situ Preparation of Metal Ligand Compositions:

Stock solutions were prepared as follows: The “metal precursor solution” is a 10 mM solution of the metal precursors in toluene. The “ligand solutions” are 5 mM solutions of the respective ligands in toluene, prepared in an array of 1 mL glass vials by adding 0.100 mL of toluene to 0.5 μmol of the ligand in a 1 mL glass vial. To each 1 mL glass vial containing ligand/toluene solution was added 0.050 mL of the metal precursor solution (0.5 μmol), to form the metal-ligand combination solutions. The resultant solutions were allowed to sit at room temperature for 1 hour prior to addition of TIBA solution and injection into the reactor, as described below.

Table 4 illustrates the ligands used:

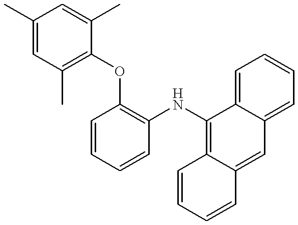

Ligand 1

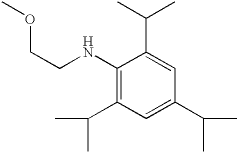

Ligand 2

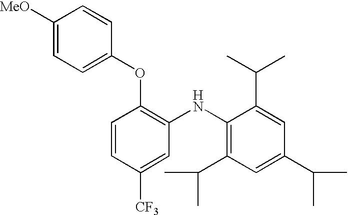

Ligand 3

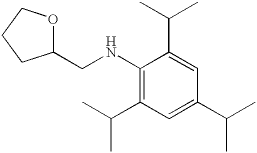

Ligand 4

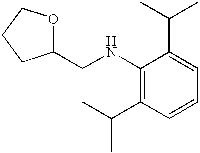

Ligand 5

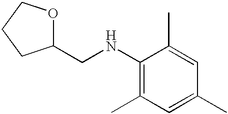

Ligand 6

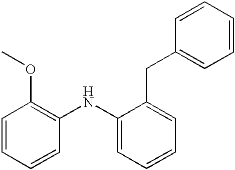

Ligand 10

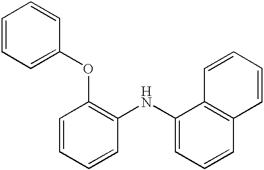

Ligand 11

Injection of Solutions into the Pressure Reactor Vessel:

After the pressurized reactor was prepared as described above, 0.100 mL (5 μmol) of a 0.05 M solution in toluene of TIBA was added to the 1 mL glass vial containing the metal-ligand combination solution. About 20 seconds later, 0.050 mL (0.25 μmol) of the “activator solution” followed immediately by 0.350 mL of toluene, were injected into the pressurized reaction vessel. About another 30 seconds later, 0.125 mL of the 1 mL vial contents, followed immediately by 0.275 mL of toluene, were injected into the pressurized reaction vessel. Results are presented in Table 5.

Polymerization:

The polymerization reactions were allowed to continue for 15 minutes or until the propylene uptake reached a pre-set limit, whichever occurred first, during which time the temperature and pressure were maintained at their pre-set levels (100 psi pressure, 75° C.) by computer control. The reaction was quenched by addition of an overpressure of carbon dioxide. The pressurized reactor was then cooled to around 60° C. and slowly vented.

Product Work Up:

The glass vial insert, containing the polymer product and solvent, was then removed from the pressure cell and removed from the inert atmosphere dry box, and the volatile components were removed using a centrifuge vacuum evaporator. After most of the volatile components had evaporated, the vial contents were dried thoroughly by evaporation at elevated temperature under reduced pressure. The vial was then weighed to determine the yield of polymer product. The polymer product was then analyzed by rapid GPC, as described above to determine the molecular weight of the polymer produced.

TABLE 5
Results of the propylene polymerizations using metal ligand compositions

| | Metal | μmol | Time | Yield | | |
|---|---|---|---|---|---|---|
| Ligand | Precursor | metal | (sec) | (mg) | Mw/1000 | Mw/Mn |
| 1 | Hf(CH₂C₆H₅)₄ | 0.25 | 900 | 70 | 2294 | 1.9 |
| 2 | Hf(CH₂C₆H₅)₄ | 0.25 | 448 | 98 | 168 | 2.0 |
| 3 | Hf(CH₂C₆H₅)₄ | 0.25 | 900 | 113 | 867 | 2.2 |
| 4 | Hf(CH₂C₆H₅)₄ | 0.25 | 125 | 344 | 118 | 2.0 |
| 5 | Hf(CH₂C₆H₅)₄ | 0.25 | 150 | 360 | 161 | 2.0 |
| 6 | Hf(CH₂C₆H₅)₄ | 0.25 | 229 | 157 | 213 | 2.8 |
| 10 | Hf(CH₂C₆H₅)₄ | 0.25 | 744 | 275 | 1185 | 2.3 |
| 11 | Hf(CH₂C₆H₅)₄ | 0.25 | 900 | 98 | 1002 | 2.4 |

As discussed herein, catalytic performance can be determined a number of different ways, as those of skill in the art will appreciate. Catalytic performance can be determined by the yield of polymer obtained per mole of metal complex, which in some contexts may be considered to be activity. Another measure of catalyst polymerization performance is molecular weight Mw. Table 5 displays the results of propylene polymerizations using ancillary ligands of the invention in combination with hafnium precursors. Surprisingly, in the presence of certain ancillary ligands, the activity as well as the molecular weights are enhanced dramatically. This result illustrates the ability of ancillary ligands of the invention to enhance the activity as well as the molecular weight performance of the hafnium metal center.

### Example 2.0

### Ethylene/1-Octene Polymerizations using [Ligand]Hf(CH₂C₆H₅)₃ Complexes

Preparation of [Ligand]Hf(CH₂C₆H₅)₃ Complexes:

In a typical preparation a solution containing 0.4 mmol of the ligand in 5 mL toluene was added to a solution containing 0.4 mmol Hf(CH₂C₆H₅)₄ in 5 mL toluene. After stirring the resultant mixture for 2 hours the toluene was removed under a stream of argon to produce the product which was washed with cold hexane and isolated as an off-white solid.

Preparation of the Polymerization Reactor Prior to Injection of Catalyst Composition:

A pre-weighed glass vial insert and disposable stirring paddle were fitted to each reaction vessel of the reactor. The reactor was then closed, and 4.85 mL of toluene followed by 0.15 mL of 1-octene was injected into each reaction vessel through a valve. The temperature was then set to 130° C., the stirring was set to 200 rpm, and the toluene/1-octene mixture was exposed to ethylene gas at 100 psi pressure. An ethylene pressure of 100 psi in the pressure cell and the temperature setting were maintained, using computer control, until the end of the polymerization experiment.

Preparation of Stock Solutions:

The “group 13 reagent solution” is a 50 mM solution of TEAL (triethylaluminum, AlEt₃ (68 μL in 10 mL)). The “activator solution” is a 5 mM solution of dimethylanilinium tetrakis(pentafluorophenyl)borate in toluene (20 mg in 5 mL toluene), heated to approximately 85° C. to fully dissolve the N,N′-dimethylanilinium tetrakis(pentafluorophenyl)borate. The [Ligand]Hf(CH₂C₆H₅)₃ solutions are 10 mM solutions of the appropriate [Ligand]Hf(CH₂C₆H₅)₃ complex in toluene. Table 6 illustrates the [Ligand]Hf(CH₂C₆H₅)₃ solutions prepared in accord with the above description.

Injection of Solutions into the Reactor Vessel:

After the toluene/1-octene mixture was saturated with ethylene at 100 psi pressure, 0.200 mL of the group 13 reagent solution followed immediately by 0.300 mL of toluene, were injected into the reaction vessel. About 30 seconds later, 0.400 mL of the “activator solution” followed immediately by 0.300 mL of toluene, were injected into the reaction vessel. About another 30 seconds later, 0.200 mL of the [Ligand]Hf(CH₂C₆H₅)₃ complex followed immediately by 0.300 mL of toluene, were injected into the reaction vessel. Results are presented in Table 7.

Polymerization:

The polymerization reactions were allowed to continue for 1 hour, during which time the temperature and pressure were maintained at their pre-set levels by computer control. After 1 hour, the ethylene flow to the reactor vessel was stopped, the temperature was allowed to drop to about 80° C. and the ethylene pressure in the cell was vented.

Product Work Up:

The glass vial insert, containing the polymer product and solvent, was then removed from the pressure cell and removed from the inert atmosphere dry box, and the volatile components were allowed to evaporate at room temperature in the air. After most of the volatile components had evaporated, the vial contents were dried thoroughly by evaporation at elevated temperature under reduced pressure. The vial was then weighed to determine the yield of polymer product. The polymer product was then analyzed by rapid GPC, as described above to determine the molecular weight of the polymer produced, and by FTIR spectroscopy to determine the ratio of 1-octene to ethylene incorporated in the polymer product, represented as the weight % of 1-octene incorporated in the polymer.

TABLE 6

| Complex | |
|---|---|
| 1 | 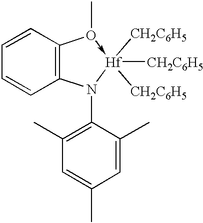 |
| 2 | 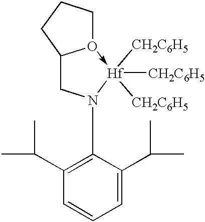 |

TABLE 7
Use of [Ligand]Hf(CH₂C₆H₅)₃ complexes as catalysts for
ethylene/1-octene copolymerizations:

| | μmol | | Copolymer | | wt. % |
|---|---|---|---|---|---|
| Complex | Hf | Temp. (° C.) | yield (mg) | Mw/1000 | 1-Octene |
| 1 | 2.0 | 130 | 109 | 54 | 29 |
| 2 | 2.0 | 130 | 273 | 56 | 12 |

### Example 3.0

### Ethylene/1-Octene Polymerizations using a [Ligand 1]Hf(NMe₂)₃ Complex:

Preparation of the [Ligand 1]Hf(NMe₂)₃ Complex:

The synthesis of [(2,4,6-Me₃-C₆H₂)OC₆H₄N(C₁₄H₉)]Hf(NMe₂)₃ is shown below:

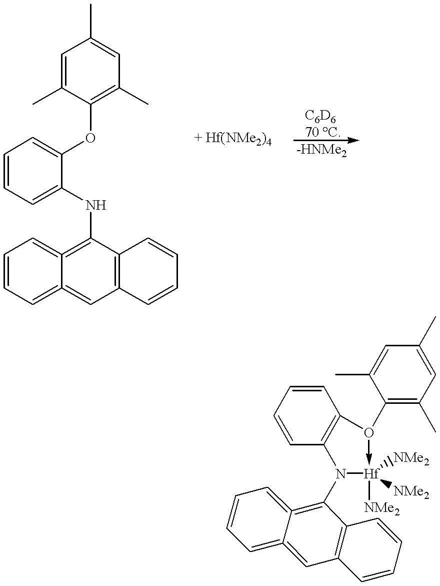

182 mg (0.45 mmol) of Ligand 1, (2,4,6-Me₃C₆H₂)OC₆H₄N(Cl₄H₉), was dissolved in 3 mL benzene and this solution was added dropwise to a solution of Hf(NMe₂)₄ (184 mg, 0.52 mmol) in benzene. The open reaction mixture (in an inert atmosphere dry box) was heated to 70° C. and the solvent was boiled off over the course of an hour, yielding a yellow solid. The product was dried in vacuo and then recrystallized from pentane at −35° C. (recrystallized yield 157 mg, 49%). ¹H NMR (C6D6; δ) 8.55 (d, 2, anth) 8.10 (s, 1, anth), 7.9(m, 2, anth), 7.35 (m, 4, anth), 6.73 (s, 2, Mes), 6.52 (m, 2, C₆H4), 6.3 (t, 1, C₆H4), 6.1 (d, 1, C₆H4), 2.50 (s, 18, NMe₂), 2.32 (s, 6, Mes), 2.12 (s, 3, Mes).

Stock Solutions:

The “group 13 reagent solutions” are 0.20 M solutions in toluene of di-isobutylaluminum hydride (DIBAL-H), or tri-n-octylaluminum (TOA), or TIBA. The “activator solution” is a 5 mM solution of N,N′-dimethylanilinium tetrakis(pentafluorophenyl)borate in toluene, heated to approximately 85° C. to fully dissolve the N,N′-dimethylanilinium tetrakis(pentafluorophenyl)borate. The “metal precursor solution” is a 5 mM solution of [(2,4,6-Me₃-C-₆H₂)OC₆H₄N(C₁₄H₉)]Hf(NMe₂)₃ in toluene.

Preparation of the Polymerization Reactor Prior to Injection of Catalyst Composition;

A pre-weighed glass vial insert and disposable stirring paddle were fitted to each reaction vessel of the reactor. The reactor was then closed, 0.10 mL of a 0.02 M solution in toluene of DIBAL-H or TOA or TIBA (chosen to match the identity of the “group 13 reagent solution” for each experiment), then 3.8 mL of toluene, were injected into each pressure reaction vessel through a valve. The temperature was then set to 130° C., and the stirring speed was set to 800 rpm, and the mixture was exposed to ethylene gas at 100 psi pressure. An ethylene pressure of 100 psi in the pressure cell and the temperature setting were maintained, using computer control, until the end of the polymerization experiment.

Injection of Solutions into the Pressure Reactor Vessel:

After the pressurized reactor was prepared as described above, 0.120 mL of a “group 13 reagent solution” (0.20 M solution in toluene of di-isobutylaluminum hydride (DIBAL-H), or tri-n-octylaluminum (TOA), or TIBA, corresponding to 24 μmol of the “group 13reagent”) was added to a 1 mL glass vial in an array. About 20 seconds later, 0.032 mL of a 0.5 M 1-octene solution in toluene (16 μmol of 1-octene) was added to the 1 mL same vial. About 20 seconds later, 0.160 mL of a 5 mM solution (0.80 μmol) of [(2,4,6-Me₃C₆H₂)OC₆H4N(C₁₄H₉)]Hf(NMe₂)₃ in toluene (the “metal precursor solution”) was added to the 1 mL same vial, followed by 0.008 mL of toluene.

About 9 minutes after adding the “metal precursor solution” to the 1 mL glass vial, 0.42 mL of 1-octene followed immediately by 0.38 mL of toluene, were injected into the pressurized, stirred, and heated, reaction vessel containing the mixture of toluene and either DIBAL-H or TOA or TIBA, saturated with ethylene at 100 psi pressure. Next, about 40 seconds later, 0.192 mL (0.96 μmol) of the “activator solution” was added to the 1 mL vial. About 30 seconds later, 0.256 mL of the 1 mL vial contents (corresponding to 0.4 μmol of Hf), followed immediately by 0.144 mL of toluene, were injected into the pressurized reaction vessel, followed immediately by a further 0.400 mL of toluene.

Polymerization:

The polymerization reaction was allowed to continue for 10minutes, during which time the temperature and pressure were maintained at their pre-set levels by computer control. After 10 minutes, the reaction was quenched by addition of an overpressure of carbon dioxide. The pressurized reactor was then cooled to around 80° C. and slowly vented.

Product Work Up:

The glass vial insert, containing the polymer product and solvent, was then removed from the pressure cell and removed from the inert atmosphere dry box, and the volatile components were removed in a centrifuge evaporator under reduced pressure. The vial contents were then dried thoroughly by evaporation at elevated temperature under reduced pressure. The vial was then weighed to determine the yield of polymer product. The polymer product was then analyzed by rapid GPC, as described above, to determine the molecular weight of the polymer produced, and by FTIR spectroscopy to determine the ratio of 1-octene to ethylene incorporated in the polymer product, represented as the weight % of 1-octene incorporated in the polymer. Results are presented in the Table 8:

TABLE 8
Results of the ethylene/1-octene copolymerizations using the Ligand 1
complex [(2,4,6-Me₃C₆H₂)OC₆H₄N(C₁₄H₉)]Hf(NMe₂)₃

| | group 13 | μmol | Yield | | | Wt. % |
|---|---|---|---|---|---|---|
| Example | reagent | Hf | (mg) | Mw/1000 | Mw/Mn | 1-Octene |
| 3.1 | DIBAL-H | 0.4 | 65 | 33 | 1.6 | 26 |
| 3.2 | TOA | 0.4 | 72 | 30 | 1.6 | 27 |
| 3.3 | TIBA | 0.4 | 124 | 76 | 3.0 | 29 |

It is to be understood that the above description is intended to be illustrative and not restrictive. Many embodiments will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated herein by reference for all purposes

What is claimed is:

1. A composition comprising
(1) a ligand characterized by the following general formula: 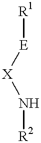
wherein, E is selected from O, S, Se, Te; each R¹ and R² is independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof; X is any covalent bridging moiety provided that X is not a benzylic bridge where the benzylic carbon atom is bound to the NHR fragment and optionally, R¹ and/or R² may joined together with X in a ring structure;
(2) a metal precursor compound characterized by the general formula M(L)ₙ where M is a metal selected from Groups 3, 4 and the lanthanides; L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, carboxylates, thio, 1,3-dionates, oxalates, carbonates, nitrates, sulphates, and combinations thereof; n is 1, 2, 3, 4, 5, 6, 7, 8, or 9; and
(3) optionally, at least one activator;
with the provisio that when M is zirconium, then the ligand is not a compound according to formula XVI: 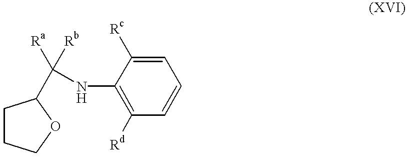
wherein each R^{a} and R^{b} are each independently selected from the group consisting of alkyl, aryl, substituted aryl, heteroaryl, substituted heteroaryl and hydrogen; and R^{c} and R^{d} are each independently selected from the group consisting of alkyl, aryl and hydrogen.

2. The composition of claim 1, with the further proviso that M is not zirconium when R¹ and X are joined together in a ring structure.

3. The composition of claim 1 in which the ligand is not a compound according to structure (IIa) or (IIb), where M′ is zirconium.

4. The composition of claim 1 in which the ligand is not a compound according to structure (IIa) or (IIb).

5. The composition of claim 1 in which the ligand is a compound according to formulae (III), (IV), (V), (VI), (VII), (VIII), (IX) (X) and (XI).

6. The composition of claim 5 in which the metal precursor is substantially pure with respect to the metal.

7. The composition of claim 6 in which the metal is hafnium.

8. A composition comprising a ligand characterized by formula (III), (IV), (V), (VI), (VII), (VIII), (IX), (X) or (XI);
a metal precursor compound characterized by the general formula M(L)ₙ where M is hafnium; L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, carboxylates, thio, 1,3-dionates, oxalates, carbonates, nitrates, sulphates, and combinations thereof; n is 1, 2, 3, 4, 5, 6, 7, 8, or 9; and
optionally, at least one activator.

9. The composition of claim 8 in which the metal precursor compound is about 90% or more pure with respect to the metal.

10. A metal ligand complex characterized by the following formula: 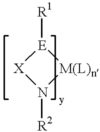
wherein, E is selected from O, S, Se, Te; each R¹ and R² is independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof; X is any covalent bridging moiety provided that X is not a benzylic bridge where the benzylic carbon atom is bound to the NHR² fragment; and optionally, R¹ and/or R² may joined together with X in a ring structure; M is a metal selected from Groups 3, 4 and the lanthanides; L is a ligand which is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, carboxylates, thio, 1,3-dionates, oxalates, carbonates, nitrates, sulphates, and combinations thereof; n′ is 1, 2, 3, 4, 5, 6; and when M is a Group 3 or lanthanide metal, y may be 1 or 2; and when M is a Group 4 metal, y may be 1, 2, or 3; provided that the metal ligand complex is not a complex according to formula (XXVII) in which M′ is zirconium.

11. The metal ligand complex of claim 10 with the proviso that when E is O and R¹ and X are joined together in a non-aromatic ring structure, then M is other than zirconium.

12. The metal ligand complex of claim 10 with the proviso that when R¹ and X are joined together in a ring structure, then M is other than zirconium.

13. The metal ligand complex of claim 10 which is not characterized by the formula (XVIII) where M′ is zirconium.

14. The metal ligand complex of claim 10 which is characterized by a formula selected from the group consisting of (XIX), (XX), (XXI), (XXX), (XXXI), (XXXII), (XXXIII), (XXXIV) and (XXXV).

15. The metal ligand complex of claim 10 which is substantially pure with respect to the metal.

16. The metal ligand complex of claim 15 in which the metal is hafnium.

17. A metal ligand complex which is characterized by either of the following formulae: 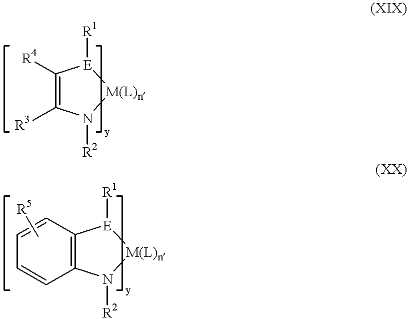
wherein, E is selected from O, S, Se, Te; each R¹ and R² is independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof; M is a metal selected from Groups 3, 4 and the lanthanides; and L is independently chosen from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, hydrido, allyl, diene, seleno, phosphino, carboxylates, thio, 1,3-dionates, oxalates, carbonates, nitrates, sulphates, and combinations thereof; y is 1, 2 or 3; and n′ is 1, 2, 3, 4, 5, 6.

18. A metal ligand complex characterized by the following formula: [chemical structure]
where M is hafnium; E is selected from the group consisting of O, S, Se, and Te; y is 1, 2 or 3; n′ is 1, 2, 3, 4, 5, 6; R², R⁶ and R⁷ are each independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof; and each R⁸ is independently selected from the group alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof.

19. The metal ligand complex of claim 18 characterized by the following formula: 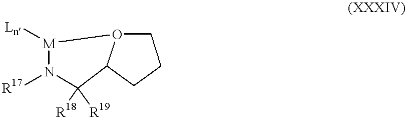
wherein R¹⁷ is aryl or substituted aryl; R¹⁷ and R¹⁵ are independently hydrogen, alkyl, substituted alkyl or aryl; and M, L and n′ are as previously defined.

20. A metal ligand complex characterized by a formula selected from the group consisting of (XIX), (XX), (XXI), (XXX), (XXXI), (XXXII), (XXXIII), (XXXIV), and (XXXV) in which M is hafnium.

21 The metal ligand complex of claim 20 which is substantially pure with respect to the hafnium.

22. A polymerization reaction or process employing a composition according to claim 1.

23 A polymerization reaction or process employing a composition according to claim 2.

24. A polymerization reaction or process employing a composition according to claim 3.

25. A polymerization reaction or process employing a composition according to claim 4.

26. A polymerization reaction or process employing a composition according to claim 5.

27. A polymerization reaction or process employing a composition according to claim 6.

28. A polymerization reaction or process employing a composition according to claim 7.

29. A polymerization reaction or process employing a composition according to claim 8.

30. A polymerization reaction or process employing a composition according to claim 9.

31. A polymerization reaction or process employing a metal ligand complex according to claim 10.

32. A polymerization reaction or process employing a metal ligand complex according to claim 17.

33. A polymerization reaction or process employing a metal ligand complex according to claim 18.

34. A polymerization reaction or process employing a metal ligand complex according to claim 20.

35. A polymerization reaction or process employing a metal ligand complex according to claim 21.

36. The process of any one of claims 22-35 wherein the at least one activator comprises an ion forming activator and, optionally, a group 13 reagent.

37. The process of any of claims 22-35 wherein the at least one activator comprises an ion forming activator and, optionally, a divalent reagent.

38. The process of any one of claims 22-35 wherein the at least one activator comprises an ion forming activator and, optionally, an alkali metal reagent.

40. A process for catalytically polymerizing a monomer comprising subjecting the monomer to polymerization conditions in the presence of a catalyst composition, wherein said catalyst composition comprises a metal ligand complex according to any one of claims 1, 8, 16-18 and 20.

41. The process of claim 40 wherein said at least one monomer is an olefin, diolefin or acetylenically unsaturated compound.

42. A process for polymerizing a monomer, comprising providing a reactor, providing at least one monomer to said reactor and providing a composition or catalyst to said reactor, wherein said composition or catalyst is defined as in any one of claims 1, 8, 16-18 and 20 and subjecting said reactor contents to polymerization conditions.

43. The process of claim 42 wherein said at least one monomer is an olefin, diolefin or acetylenically unsaturated compound.

44. An array of compounds wherein each compound of the array is different from the other compounds of the array, and there are at least 8 compounds in the array, wherein each of the compounds is characterized by the general formula: 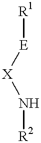
wherein, E is selected from O, S, Se, Te; each R¹ and R² is independently selected from the group consisting of hydrogen, alkyl, substituted alkyl, cycloalkyl, substituted cycloalkyl, heteroalkyl, substituted heteroalkyl, heterocycloalkyl, substituted hetercycloalkyl, aryl, substituted aryl, heteroaryl, substituted heteroaryl, alkoxyl, aryloxyl, silyl, boryl, phosphino, amino, thio, seleno, and combinations thereof; X is any covalent bridging moiety excluding a benzylic bridge where the benzylic carbon atom is bound to the NHR fragment; and optionally, R¹ and/or R² may joined together with X in a ring structure.

45. The array of claim 44, wherein each compound additionally comprises a metal precursor M(L)ₙ where M is a transition metal or main group metal or lanthanide metal and L is independently each occurrence selected from the group consisting of halide, alkyl, substituted alkyl, cycloalkyl, substituted cycloalkyl, heterocycloalkyl, substituted heterocycloalkyl, cyclopentadienyl, substituted cyclopentadienyl, aryl, substituted aryl, heteroaryl, substituted heteroaryl, alkoxy, aryloxy, hydroxy, boryl, silyl, hydride, thio, seleno, phosphino, amino, amine, carboxylates, 1,3-dionates, oxalates, carbonates, nitrates, sulfates, perchlorates, sulfonates phosphonates and combinations thereof; and n is an integer from 1-9.
